(19) United States
(12) Patent Application Publication
(10) Pub. No.: US 2007/0088597 A1
(43) Pub. Date: Apr. 19, 2007

(54) Method of tracking social services

(75) Inventors: Toby Herr, Chicago, IL (US); Charles Chang, Chicago, IL (US)

Correspondence Address: Welsh & Katz, Ltd.;22nd Floor, 120 South Riverside Plaza, Chicago, IL, 60606-3945, US

(73) Assignee: Project Match Families in Transition, Chicago, IL (US)

(21) Appl. No.: 11/253,856

(22) Filed: Oct. 19, 2005

(51) Int. Cl. G06F 15/02

(52) U.S. Cl. 705/9

(57) ABSTRACT

A method and apparatus are provided for tracking a plurality of social services clients. The method may be at least partially implemented by the programmed computer and may include the step of providing a social services client of the plurality of social services clients with a customized set of services that depend upon a level of service required by the client. The method may also include the steps of the programmed computer prompting a case worker to record the set of services received by the client within a client file located within the programmed computer, prompting the case worker to select one or more client objectives, recording the client objectives selected by the case worker within the client file as a pending client objective where each client objective is a case worker defined action that is undertaken by the client and prompting a case worker to make contact with the social services client at an end of a regularly scheduled follow-up time period for each of the one or more pending client objectives.

### FIELD OF THE INVENTION

The field of the invention relates to social services and more particularly to methods of tracking the progress of social services clients.

### BACKGROUND OF THE INVENTION

The field of social services is a difficult and challenging environment. People who seek and receive social services typically do so because they are unemployed, low-income, poorly educated, and lacking many resources available to people with higher incomes and standards of living.

In order to help their clients, social service agencies often set up permanent facilities where clients may come to receive help. Help may be provided in any number of ways. Clients may be counseled by case workers on ways to improve their personal situations. Help may be provided in obtaining daycare for children while their parents look for jobs. Case workers may help their clients in preparation of resumes. Bus tokens may be provided free of charge to allow their clients to look for jobs.

Once a client has found a job, the challenge may become even more difficult for a case worker. Additional challenges may arise in helping the client establish a stable home situation. Financial counseling may be required to help the client manage limited resources. Divorce, injury, recurrent drug dependencies or other personal problems may compound the client's problems.

Often the only way that a case worker can provide long term help for their clients is through continued contact and support. However, maintaining continued contact and offering support is difficult for any number of reasons.

Case workers often handle very large numbers of client cases at a time. Caseworkers face the daunting task of trying to provide time-consuming personal assistance to each client while not letting any single client fall through the cracks. Clients may not keep case workers apprised of their addresses or employment situations. This balancing can be very challenging for case workers. Because of the importance of social service organizations and their case workers, a need exists for ways to better help case workers offer the benefits that their clients so desperately need.

### SUMMARY

A method and apparatus are provided for tracking a plurality of social services clients. The method may be at least partially implemented by the programmed computer and may include the step of providing a social services client of the plurality of social services clients with a customized set of services that depend upon a level of service required by the client. The method may also include the steps of the programmed computer prompting a case worker to record the set of services received by the client within a client file located within the programmed computer, prompting the case worker to select one or more client objectives, recording the client objectives selected by the case worker within the client file as a pending client objective where each client objective is a case worker defined action that is undertaken by the client and prompting a case worker to make contact with the social services client at an end of a regularly scheduled follow-up time period for each of the one or more pending client objectives.

### BRIEF DESCRIPTION OF THE DRAWINGS

FIG. 1 is a block diagram of a system for tracking social services clients in accordance with an illustrated embodiment of the invention;

FIG. 2 depicts a sign-in screen that may be used by the system of FIG. 1;

FIG. 3 depicts a main screen that may be used by the system of FIG. 1;

FIG. 4 depicts an orientation screen that may be used by the system of FIG. 1;

FIG. 5 depicts a set date screen that may be used with the orientation screen of FIG. 4;

FIG. 6 depicts a date entry screen that may be used with the orientation screen of FIG. 4;

FIG. 7 depicts a date change screen that may be used with the orientation screen of FIG. 4;

FIG. 8 depicts a date change confirmation screen that may be used with the orientation screen of FIG. 4;

FIG. 9 depicts an orientation date deletion screen that may be used with the screen of FIG. 4;

FIG. 10 depicts a pre-enrollee screen that may be used with the screen of FIG. 3;

FIG. 11 depicts a pre-enrollee data entry screen that may be used with the screen of FIG. 10;

FIG. 12 depicts a pre-enrollee orientation assignment screen that may be used with the screen of FIG. 11;

FIG. 13 depicts a further pre-enrollee orientation assignment screen that may be used with the screen of FIG. 10;

FIG. 14 depicts an orientation date change screen that may be used with the screen of FIG. 10;

FIG. 15 depicts an attendance entry screen that may be used with the screen of FIG. 10;

FIG. 16 depicts an attendance view screen that may be used with the screen of FIG. 10;

FIG. 17 depicts an attendance entry screen that may be used with the screen of FIG. 10;

FIG. 18 depicts an orientation attendance screen that may be used with the screen of FIG. 17;

FIG. 19 depicts an orientation entry screen that may be used with the system of FIG. 18;

FIG. 20 depicts an enrollment entry screen for a monthly client that may be used with the screen of FIG. 3;

FIG. 21 depicts an enrollment entry screen that may be used with the system of FIG. 20;

FIG. 22 depicts an enrollment entry screen for a drop-in client that may be used with the screen of FIG. 3;

FIG. 23 depicts a drop-in client data entry screen that may be used with the screen of FIG. 22;

FIG. 24 depicts a client data entry screen that may be used with the screen of FIG. 3;

FIG. 25 depicts a data entry screen that may be used with the screen of FIG. 23;

FIG. 26 depicts a data entry screen that may be used with the screen of FIG. 25;

FIG. 27 depicts a data entry screen that may be used with the screen of FIG. 26;

FIG. 28 depicts a data entry screen that may be used with the screen of FIG. 27;

FIG. 29 depicts a data entry screen that may be used with the screen of FIG. 28;

FIG. 30 depicts a monthly client services entry screen that may be used with the system of FIG. 1;

FIG. 31 depicts a client information editing screen that may be used with the screen of FIG. 3;

FIG. 32 depicts a client information editing screen that may be used with the screen of FIG. 31;

FIG. 33 depicts a service information editing screen that may be used with the screen of FIG. 3;

FIG. 34 depicts an information entry screen that may be used with the screen of FIG. 33;

FIG. 35 depicts an information entry screen that may be used with the screen of FIG. 34;

FIG. 36 depicts a information entry screen that may be used with the screen of FIG. 35;

FIG. 37 depicts a service information editing screen that may be used with the screen of FIG. 3;

FIG. 38 depicts a company selection screen that may be used with the system of FIG. 1;

FIG. 39 depicts a company information entry screen that may be used with the system of FIG. 1;

FIG. 40 depicts a client outcome selection screen that may be used with the system of FIG. 1;

FIG. 41 depicts a client outcome information entry screen that may be used with the system of FIG. 1;

FIG. 42 depicts a further client outcome information entry screen that may be used with the system of FIG. 1;

FIG. 43 depicts a client addition/entry screen that may be used with the system of FIG. 1;

FIG. 44 depicts a client outcome error screen that may be used with the system of FIG. 1;

FIG. 45 depicts a client outcome edit screen that may be used with the system of FIG. 1;

FIG. 46 depicts a client outcome selection screen that may be used with the system of FIG. 1;

FIG. 47 depicts a client outcome change screen that may be used with the system of FIG. 1;

FIG. 48 depicts a client outcome summary screen that may be used with the system of FIG. 1;

FIG. 49 depicts a statistics selection screen that may be used with the system of FIG. 1;

FIG. 50 depicts a statistics print screen that may be used with the system of FIG. 1;

FIG. 51 depicts a Tickler selection screen that may be used with the system of FIG. 1;

FIG. 52 depicts a To Do selection screen that may be used with the system of FIG. 1;

FIG. 53 depicts a To Do data entry screen that may be used with the system of FIG. 1;

FIG. 54 depicts a To Do selection screen that may be used with the system of FIG. 1;

FIG. 55 depicts a To Do editing screen that may be used with the system of FIG. 1; and

FIG. 56 an outcomes group and activity codes that may be used by the system 1.

### DETAILED DESCRIPTION OF AN ILLUSTRATED EMBODIMENT

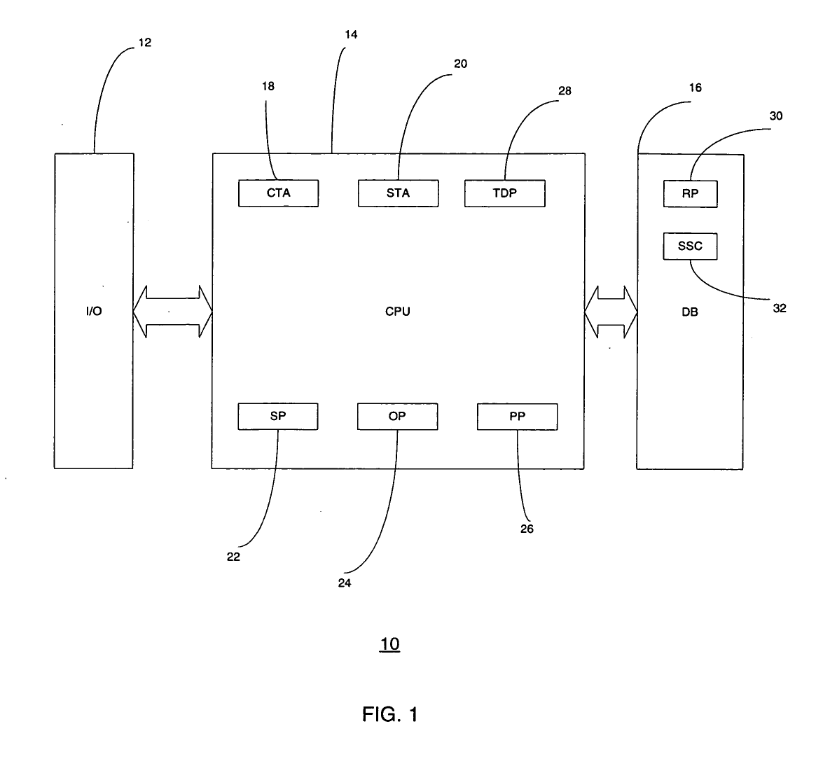

FIG. 1 is a block diagram of a tracking system 10 for social services clients shown generally in accordance with an illustrated embodiment of the invention. The system 10 differs from prior systems because of the challenging environment in which it operates. For example, social services clients often do not have permanent addresses, may use aliases as names and often cannot be relied upon or be motivated to do what is in their best interests. The problem of identification requires the system 10 to use methods of identification that are not necessarily based upon street address or, even name. The problem of motivation requires the system 10 to facilitate the creation and tracking of client history and objectives and that allows for client entry, exit and re-entry into the program at the same, higher or even at lower levels without loss of continuity.

Turning first to features and objectives, an overview of the philosophy underlying the operation of the system 10 will be provided. Once an overview has been provided, a detailed description of the use of the system 10 will be provided.

As used herein, an objective of a social services client is a personal objective of the client. For the purpose of this description, it is not a social objective of society as a whole even though society may benefit from the client's activities. For example, a social objective of a client may be overcoming a substance abuse problem, obtaining a Graduate Equivalent Degree (G.E.D.), getting a job, or without outside help, paying off his debts, etc. Similarly, an outcome may be an objectively defined status of a social service client at some predetermined period of time.

The system 10 provides a reliable enrollment tracking protocol. In this regard, every person who enrolls in the program (i.e., “participant” or “client”) is assigned a unique number which is never re-assigned to anyone else, whether or not the participant is actively participating in the program. This allows clients to be tracked no matter where they live or even when their names change due to divorce or otherwise.

In addition, each client has different needs. Every participant is assigned a unique service mix based on objective criteria derived from a written application and a face-to-face meeting with at least one staff person. The system uses unique objective criteria to determine which service mix is appropriate for a participant at the time the participant enrolls in the system.

The system uses a unique method for tying each service mix to a particular follow-up schedule. The system uses a different set of unique objective criteria to determine when a participant should be reassigned to a different service mix and to different follow up protocols.

The system may serve first-time clients or repeat (multi-year) participants. The system enables staff to enroll first-time participants at any time while continuing to provide services on a cumulative basis to participants enrolled in previous years. In addition, the system converts enrolled participants who were active in the program to inactive status based on unique objective criteria. The system allows an inactive participant to resume participation in the program based on a staff reassessment that takes into account the prior services provided to the participant and the participant's outcome history and current situation.

The system 10 distinguishes between services provided to clients and the outcomes achieved by those clients. The system distinguishes between staff services and participant outcomes using unique codes and forms for each.

The system uses a unique formula, sets of categories and codes to record every service the program provides either directly to a participant or on behalf of a participant regardless of the service mix to which the participant is assigned.

The system allows descriptive, anecdotal case-note records and documentation of services provided to the participant that are converted into numerical, quantifiable information that describes which participant received what services and when the participant received the services. The information forms part of a permanent record saved by the system.

The system distinguishes between one-time outcomes—i.e., outcomes that occur in a discrete period of time with no need for follow-up and over-time outcomes—i.e., outcomes that continue over time and need to be tracked.

Over-time outcomes are tracked using a unique set of codes (i.e., beginning codes, interim codes, and end codes—which together evaluate the immediate and long-term results of specific over-time outcomes).

The system uses a monthly status update structure even when staff obtain the participant outcome information and record it on a non-monthly basis.

In general, the system 10 may include five basic groups of features that capture interdependent qualitative and quantitative data about program participants, employers, service providers and staff, which are described in more detail below. At a minimum, it captures and maintains participant demographics, services provided by case managers to program participants and monthly “outcomes” for participants (what happens or doesn't happen to each participant each month). Beyond this, it serves as a tool that structures the practice of staff. Driven by the program's protocols for operation, the system helps case managers (direct service staff or case workers) to effectively provide services to and track participant activity on a monthly basis. Additionally, using the reporting features of the system, administrators and direct-service staff can generate statistical information about clients and staff to help analyze program delivery and results. The system itself may also provide helpful messages and warnings.

The processing of tracking will be discussed first. In this regard, a client tracking application 18 within the system 10 tracks qualitative and quantitative information about participants (clients), staff (case workers) and the employers, institutions and service providers with who participants (clients) become involved through the activity of the case workers.

The client tracking application 18 allows users to collect and maintain comprehensive demographic data about participants in the program. Using a series of screens, users can enter detailed data on a participants, age, race, address, family composition, marital status, educational history, financial history, employment history. It should be noted in this regard that reference to a method step also refers to the structure (i.e., the computer program or processor) that accomplishes that step.

In addition, a services tracking application 20 within the system 10 allows the user to enter highly detailed information about the services (efforts of Staff on behalf of participants) that Staff provide to program participants. These services are user-defined, and any group of users may therefore select and refine the services they wish to track. As used herein, the term “user” refers to the organization that uses the system 10 to service its clients through its caseworkers.

On one screen within the system, the user can enter the date and duration of service, the general category of service, and the specific type of service (e.g., from a list). This allows the user, whether a case manager seeking to provide customized individual service to a client or an administrator seeking to analyze staff time spent on service delivery, to track: 1) the types of services offered to a participant or group of participants (e.g., women, African-Americans, employed clients, etc.); 2) the amount of time spent, on each participant or a group of participants; 3) the amount of time spent by a staff person delivering a category of service (e.g., “employment related”, “finance-related”) or a particular service (e.g., resume creation, assistance registering for a GED class, etc.); 4) the frequency of services obtained by a particular participant or group of participants; and 5) the frequency of contact with a particular participant or group of participants.

The system 10 also provides users with features to track “outcomes” for participants. Outcomes are defined as actions taken by or things that happen to participants, often as a result of receiving services. For example, if a case manager assists a participant in preparing a resume and practicing for a job interview and the participant obtains the job, the objective of the service is to obtain a job and the placement in the job is an outcome.

The system 10 allows users to track the status of an outcome over time. Many outcomes are just the beginning of a series of activities undertaken by a participant, the status of which will change as time goes by. In other words, they “evolve”. Using the Status Screens on the system, a user can track the “evolution” of outcomes. For example, if a participant receives a promotion in the job, is fired or quits, each of these occurrences is a separate outcome that can be entered, recorded, and tracked by participant or group of participants. This information is then usable by case managers to assist participants with future services.

Employer/service provider tracking features will be discussed next. In this regard, the system 10 provides a method for case managers and agency administrators to collect and maintain data about the other organizations with whom the participants interact, e.g., employers, schools and colleges, training programs and social service providers. The system 10 collects basic data about these entities such as addresses and the name of a contact person. It also collects and allows the user to analyze data about industry hiring trends, hiring seasons of particular employers, special requirements of employers or programs, each of which allow case managers to provide better information to participants seeking a job or placement.

Like the participant tracking features, the data entered about employers, educational institutions, and service providers can be sorted and tracked in numerous ways that help staff and administrators better assist participants. For example, the system 10 can record, find, sort and report on employers within a particular industry that hire during a specific time of year.

Staff tracking features will be discussed next. In any service-based organization, it is important for administrators to understand how staff spend their time. The system 10 includes features, alluded to above, that can tell how much time each staff person spends delivering particular types of services to participants or groups of participants. In doing so, it assists administrators in better allocating staff resources to best assist participants.

A core component of the system's approach to workforce development is consistent contact with participants over time. This generally means that case management staff will contact each participant at least once a month for as long as the participant wishes to remain part of the program. The system 10 “builds in” this operational protocol by including a “tickler feature” provided by a prompting application (program) 26 which automatically reminds each case manager (case worker) to contact each participant for whom no contact has been recorded or service entered in a month. The reminder appears every time the case manager logs on to the system 10, and will not disappear until a service or contact information is entered for the participant. The tickler feature of the system 10 differs from prior art devices of the same type by the fact that entry of a client objective automatically activates the tickler feature for each objective of that client.

In addition to monthly contact with participants, a workforce development program of the system 10 has several other regular, time-sensitive operational protocols (e.g., a To Do processor 28). The system 10 assists staff and administrators users in following these protocols by allowing users to set up individual and group “TO DO” lists.

Like the Tickler feature, the TO DO list feature works by functioning as a persistent reminder to the individual user or group of users that a specific action is required. The TO DO list reminder screen appears every time the user logs on to The system 10 with a list of tasks, and the reminder does not deactivate until the user performs the task(s) required and enters indication thereof within the system 10.

Reporting features will be discussed next. One feature is a fast statistics (Fast Stat) feature of a statistics processor 22. Using the “Fast Stat” screens, users can create and print out “snapshot” statistical reports about a variety of data captured by the system 10, including, for example, the following: 1) the number of new participants within a specific time period; 2) the number of active or inactive participants within a specific time period; 3) the number of participants with certain types of outcomes

Data grouping and sorting features will be discussed next. In this regard, statistics processor 22 of the system 10 can also create more detailed reports using its multiple data grouping and sorting functions. For example, the system may: 1) alphabetized or chronologically arranged lists of participants and employers; 2) provide caseloads of staff persons organized by type of participant; 3) provide services delivered to particular participants or groups of participants or 4) provide a list of types of Services delivered.

These features of the statistics processor 22 are useful for analyzing staff use of time and allocation of resources, tailoring services provided to participants, and providing data that can be used in policy research and development for the field of workforce development.

Retrieval features will be discussed next. Because of the large and complex amount of data that the system 10 maintains, it also contains a searching and retrieval feature (program) that allows users to find specific data and create reports by entering limiting descriptors. For example, the system 10 may find lists of clients by race, sex, or age or lists of companies by zip code.

Security features may be discussed next. The system 10 allows users to maintain sensitive and often confidential data about participants. Because of this, it contains features which limit access to certain types of users depending on the nature of the data and/or the user's authority to make the changes to the system. For example, the default access for each case manager is only to his/her own caseload of participants. Case managers may not change the list of services or types of outcomes without being given specific access by the system's administrator.

In general, the system 10 has a database, entry, retrieval and reporting system (e.g., processor 30) that: 1) that distinguishes among clients based on the level of service needed and the frequency of follow-up contact; 2) that supports two distinct processes—the tracking of staff efforts on behalf of a client (referred to as services), and the tracking of client achievements (referred to as outcomes); 3) that requires updating of monthly outcome records, regardless of whether or not staff is required to contact clients on a monthly basis or at some other regular interval; 4) that distinguishes between those outcomes that occur in one day and those outcomes that occur over time; and 5) that uses a separate set of codes to indicate the status of outcomes that occurs over time. In order to provide the database 16 with the information needed to provide these features, the system 10 prompts the caseworker with a number of forms (i.e., screens).

One of these forms is a daily service form. The Daily Service Form includes (a) a checklist of possible staff efforts on behalf of a client, (b) a place to record the amount of time spent by staff providing a service to the clients, and (c) a place to record, in narrative form, services provided that are not on the checklist, and details about any particular service.

Another form used to prompt the caseworker is a monthly tracking form. The monthly tracking form includes (a) a place to identify the client's status with regard to the level of service needed and the frequency of follow-up contact, (b) a place to record new outcomes for the first time, (c) a place to update previously recorded outcomes, (d) a place to record background information about any new outcome, and (e) a place to update background information about previously recorded outcomes.

Another form is an outcome codes form. The outcome codes form includes 1) a list of outcomes broken down by type with codes assigned to each, and 2) a clear indication of which outcomes occur in one day vs. those that occur over time, and 3) a code that indicates “no outcome for the month,” which staff need and use to maintain a complete record of monthly outcomes.

A status codes form is also provided. The Status Codes Form includes: (a) a single code that is always used for outcomes that occur in one day, (b) a set of codes for outcomes that occur over time broken down into three basic categories-new outcome status codes, ongoing outcome status codes, and exiting outcome status codes, (c) a single code, within the list of ongoing outcome status codes, that indicates that there is no change in the status of the outcome, and (d) a single code, within the list of ongoing outcomes, that indicates that the staff had no contact with the client during the month.

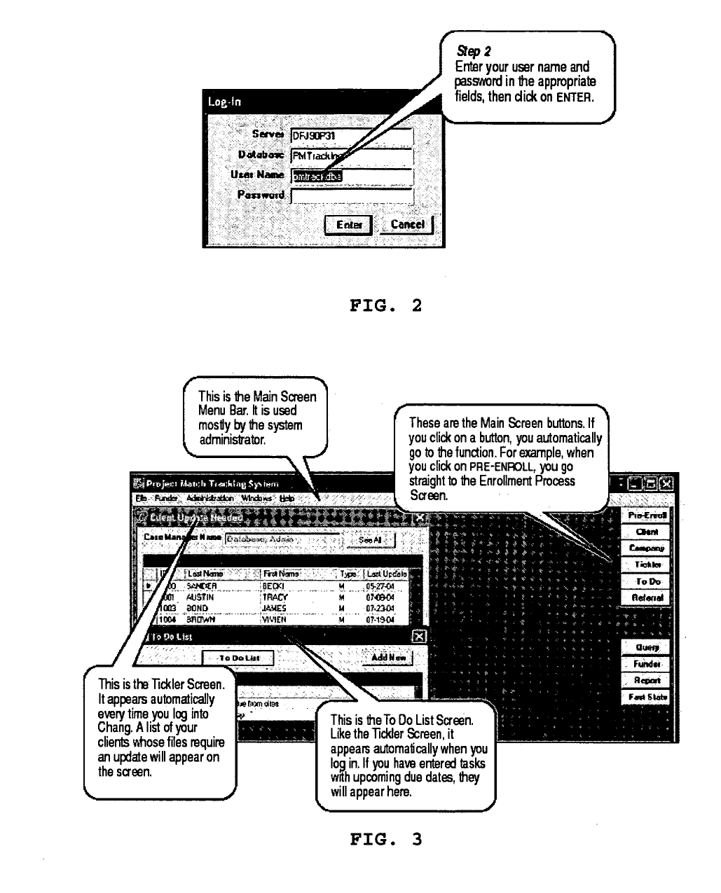

Turning now to operation of the system 10, a description will be provided as to how the system 10 is used. In this regard, once a case worker may activate an input device (e.g., a computer terminal) 12. Once the input device is activated, the user may activate an icon that initializes the system 10 (as a first step) and the log-in screen as shown in FIG. 2 appears. In a second step, as indicated in FIG. 2, the case worker (user) may enter their user name and password and activate the ENTER softkey.

Once a user name and password have been entered, the main screen of FIG. 3 may be presented. Along a left hand side may be a tickler screen. The tickler screen includes a set of prompts generated by the system 10 that includes the names of clients that the case worker needs to contact.

Also included on the main screen may be a TO DO list. The TO DO list may include reminders previously entered by the case worker. The TO DO screen differ from the tickler screen in that the TO DO screen contains reminders initiated by the case worker whereas the tickler screen contains prompts automatically generated by the system 10.

Also included on the main screen may be a main menu along a right margin. The main menu may include a PRE-ENROLL softkey, a CLIENT softkey, a COMPANY softkey, a TICKLER softkey, a TO DO softkey and a REFERRAL softkey. Each of the softkeys functions to activate a respective processing application.

The PRE-ENROLL softkey may be used to set up orientation dates for potential clients (pre-enrollees). The PRE-ENROLL softkey may also be used to enter preliminary client information, assign pre-enrollees to an orientation session, and enter orientation attendance.

The CLIENT softkey may be used to add new monthly or drop-in clients to the system 10. The CLIENT softkey may also be used to enter updates to client background information, services and outcomes.

Also included may be a COMPANY softkey. The COMPANY softkey may be used to enter information about employers, including any time periods when the employers hire, where their branches are, etc. This part of the system is also where the user may enter information on institutions and organizations to which clients are referred for education, training, treatment, or other services.

Also included is a TICKLER softkey that activates the TICKLER list discussed above. The TICKLER softkey automatically reminds the user of which clients on the case worker's caseload need their information updated. The system 10 distinguishes between monthly and quarterly clients, which distinction is reflected on the Tickler Screen.

Also included in the TO DO softkey that activates the TO DO list. The TO DO softkey may be used to create task lists with due dates for the case worker. The system 10 will display reminders to the case worker on the Main Screen as the due date approaches. It can also broadcast reminders to other users with whom the case worker is networked.

Also included is a REFERRAL softkey. The REFERRAL softkey may be used to document referrals to outside service providers, as well as the outcomes of referrals.

Also included on the main screen may be a database menu. The database menu may include a QUERY softkey, a FUNDER softkey, a REPORT softkey and a FAST STATS softkey.

The QUERY softkey may be used to request lists of clients who meet certain criteria that the system 10 tracks (for example, female clients who have children or clients who have worked for more than 12 months). This capacity is useful for creating groups that particular funders may wish to track.

The FUNDER softkey may be used to assign clients to one or more groups for tracking purposes when required by a funder. This function is available only to authorized users designated by the system administrator.

The REPORT softkey may be used to request specific printouts of program or client information over a particular period of time. The REPORTS softkey is discussed in more detail below.

The FAST STATS softkey may be used to request a one-page summary of statistical information about a user's program. The user can limit the scope of the summary by specifying the start and end dates for the summary.

The EXIT softkey may be used to log out of the system 10, closing all screens. After exiting, the user will have, again, to go through the log-in process to re-access the system.

In order to offer social services, the system 10 may be used to expedite the orientation of clients. In this regard, each new monthly client receives an “orientation” as part of the enrollment process before they start receiving services. (Drop-In clients are not required to attend orientation.) The orientation is a meeting between staff and new clients (which can be conducted in groups or one-on-one), scheduled at a specific time and location, where staff explain how the program works and clients have the opportunity to pose questions.

Clients get invited to orientation on a specific date, so it is important to set up the dates in the tracking system in advance in order to be able to accurately take attendance later. Orientations may be scheduled as follows.

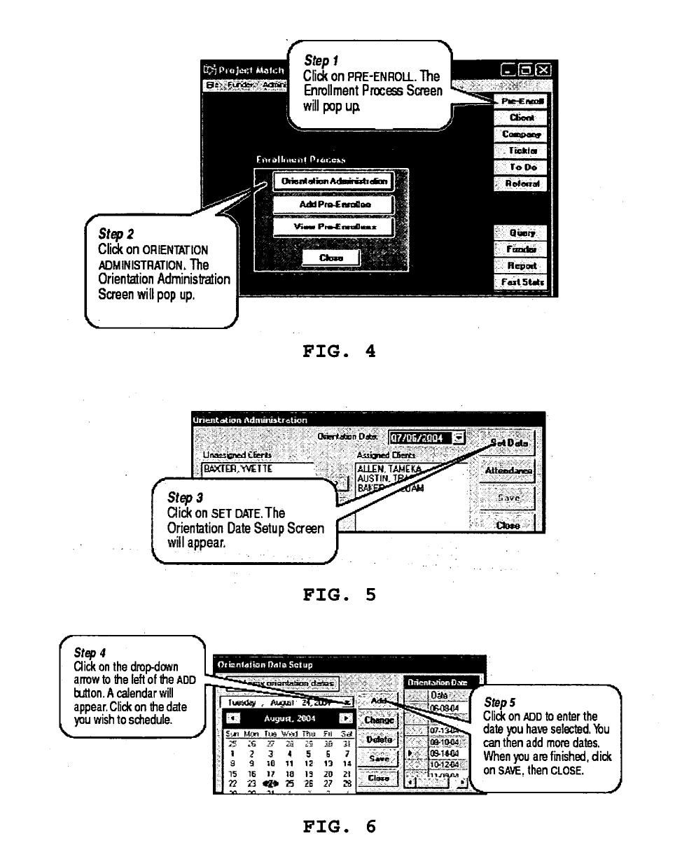

On the Main Screen, a case worker clicks on the Pre-Enroll button (step 1, FIG. 4). The Enrollment Process Screen will appear. On the Enrollment Process Screen, the case worker may click (step 2) on Orientation Administration. The Orientation Administration Screen will appear (FIG. 5).

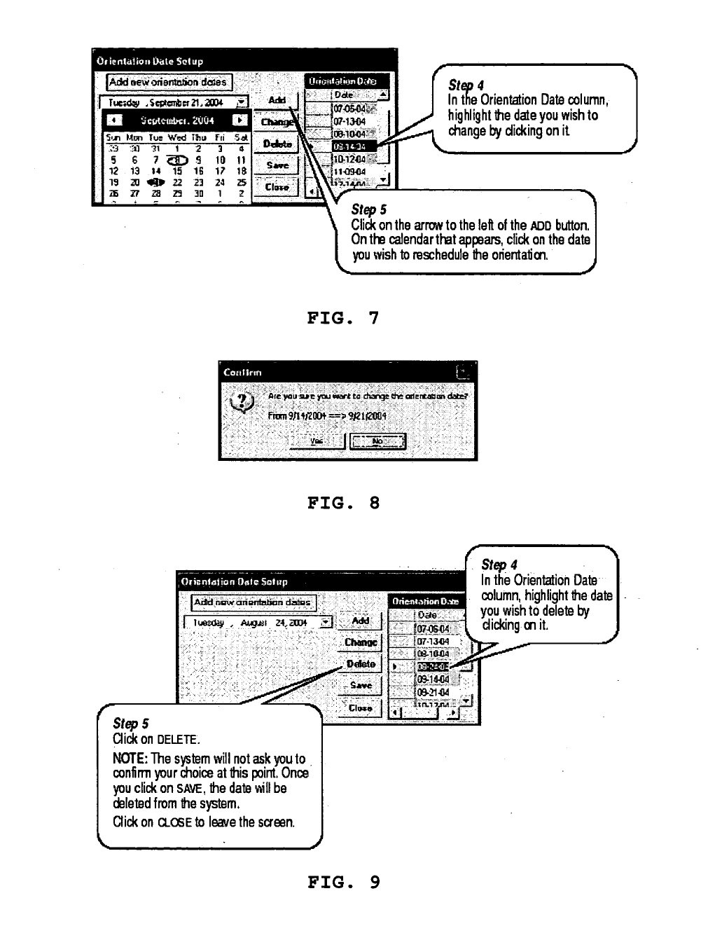

In the Orientation Administration Screen, the case worker may click on Set Date (step 3, FIG. 5). The Orientation Date Setup Screen will appear (FIG. 6).

In the Orientation Date Setup Screen, the case worker may click (step 4, FIG. 6) on the drop down arrow to the left of the “Add” button. A Calendar will appear. The case worker may then click on the date he/she wishes to select.

The case worker may click “Add” (step 5) to add the selected date to the system 10. The case worker can then add more dates in the same way. When the case worker is finished, he/she may then activate the “Save” and “Close” buttons. Activation of the “Close” softkey may cause a unique identifier to be assigned to the client and for the data to be saved in a file 32 opened specifically for the social services client.

Once an orientation has been scheduled, the scheduled orientation may be changed or deleted as follows. To change or delete a scheduled orientation, the case worker may follow steps 1-3 (FIGS. 4-5) as described above for setting up an orientation.

Next, in the Orientation Date column, the case worker highlights the date (step 4, FIG. 7) he/she wishes to change by clicking on it. The case worker may then click (step 5) on the drop down arrow to the left of the “Add” button. A calendar will appear. The case worker may then click on the reschedule date.

The case worker may then click “CHANGE” (step 6, FIG. 7). The system will send a message asking the case worker to confirm whether he/she wants to change dates. The case worker may click on “yes” (step 7, FIG. 8) followed by SAVE and CLOSE.

If the case worker should wish to delete an Orientation Date, he/she may follow steps 1-3 (FIGS. 4-5) for setting up a group orientation date. In the screen that appears (FIG. 9), the case worker may, in the orientation data column, highlight the date (step 4) he/she wishes to delete by clicking on it. The case worker may then click “DELETE” (step 5). The system will not ask the case worker to confirm his/her choice. The case worker may then click Save and Close in the Orientation Setup box.

Pre-enrollment of monthly clients may be considered next. When a new prospective client contacts the case worker or when the case worker meets with him or her, the case worker must first decide whether he/she will be a monthly client or a drop-In client. How the case worker enters information into the Tracking System depends on this decision. If the client is to be a Monthly Client, the case worker will follow the steps outlined below to pre-enroll the client. Drop-In Clients will be discussed below.

Pre-enrollment may be defined by the status of the relationship between the case worker and client. Pre-enrollment may mean the following: 1) the case worker has engaged the person in discussion; 2) the case worker has decided that the client needs case management (i.e., monthly contact); 3) the case worker has entered basic demographic information into the tracking System; 4) the case worker has assigned the person to an orientation session (or given them a one-on-one session); and 5) the case worker has recorded the client's attendance at orientation.

Tracking will be considered next. A tracking application 18 of the Tracking System has been designed to keep track of people from the moment they inquire about the program. Basic information on a prospective monthly client is entered into the tracking System as soon as possible after the case worker's first contact with them. After the case worker enters basic demographic data about them into the system, the case worker can then assign them to an orientation and record their attendance.

A monthly client may receive a full range of services provided by case workers and full access to the site's resources with assistance from case workers. Monthly clients are usually contacted once a month in order to track client progress.

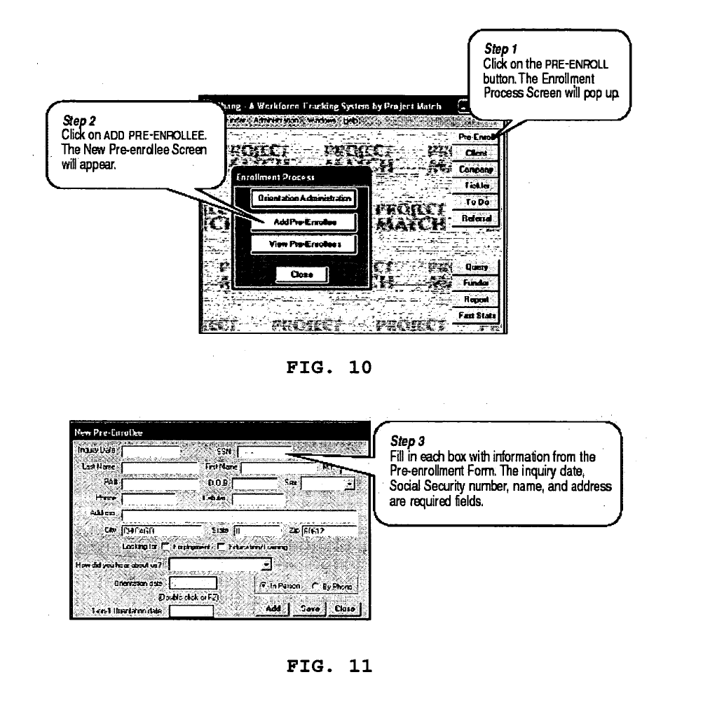

In the action steps performed using the screens of FIGS. 10 and 11, the case worker is allowed to do the following: 1) enter information about pre-enrollees; 2) assign an Orientation Date; 3) view pre-enrollees and 4) record attendance at orientation sessions. To enter information about pre-enrollees, the case worker may click on the Pre-Enroll button (step 1, FIG. 10). The case worker may then click on the ADD PRE-ENROLL softkey (step 2, FIG. 10) and a new pre-enrollee screen (FIG. 11) will appear.

The case worker may then enter as much information as the case worker has in his/her possession (step 3, FIG. 11). In the case where the client does not have a social security number, then the case worker may enter a dummy number provided by the case worker's supervisor. The supervisor may maintain a list of such dummy numbers for those cases where a client cannot be otherwise uniquely identified.

The client may then be assigned to a group orientation. In this regard, there are two ways to assign a Pre-Enrollee to a Group Orientation. Both will be demonstrated in the following Action Steps. Under a first method (FIG. 12), the case worker may enter information about a new pre-enrollee by double-clicking (step 1) on the Orientation Date box (or press F2 key). A select orientation date screen will appear (FIG. 12). The case worker may then click on the date the case worker wants (step 2) from the list in the Select Orientation Date box and then click the SELECT button.

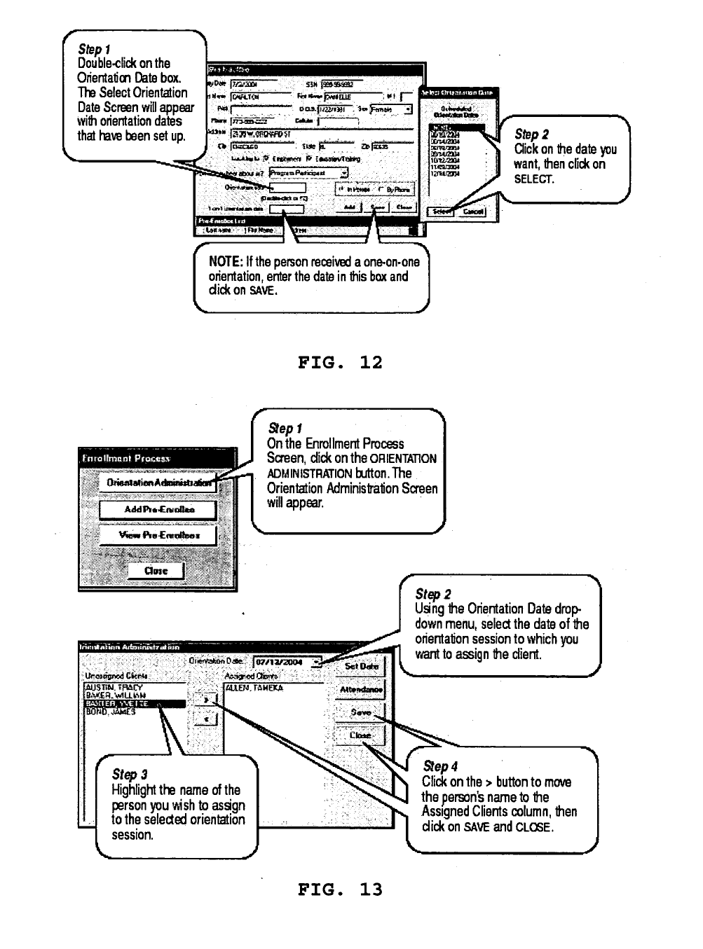

Under a second method, the case worker may assign a client to a group orientation using the Orientation Setup function (FIG. 13). On the main screen, the case worker may click on the PRE-ENROLL button. The Enrollment Process Screen may appear. The case worker may click on the Orientation Administration button. The case worker may then select the orientation session (step 2) that the case worker want to assign clients from the drop down menu on the Orientation Administration screen. In the left-hand column of unassigned clients, the case worker may click (step 3) on the name of the person the case worker wishes to assign to the date. Finally, the case worker may click on the >button (step 4) to move that name to the right-hand column of assigned clients. The case worker may then click SAVE and CLOSE.

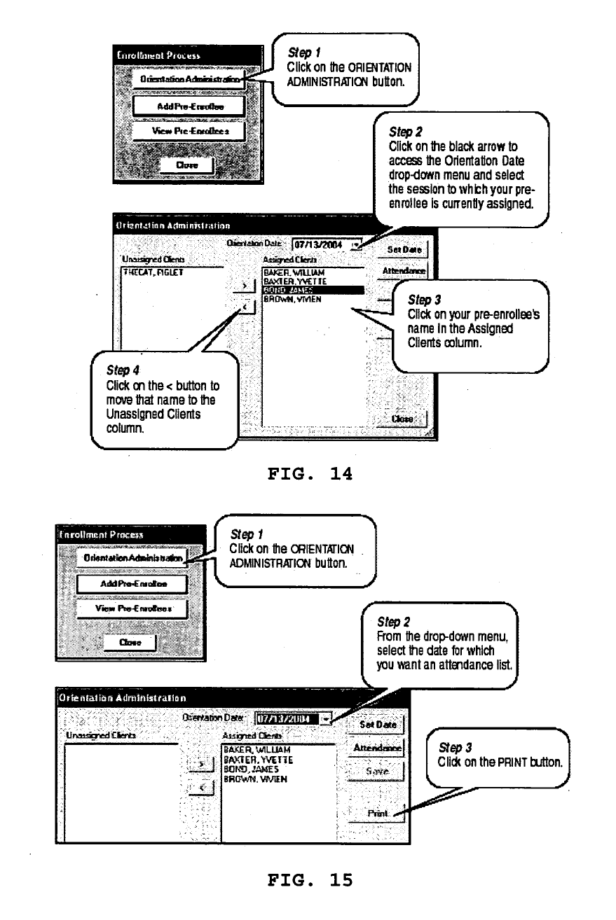

The case worker may also change a group orientation date for a pre-enrollee. To change the group orientation date, the case worker may click (step 1, FIG. 14) on the Orientation Administration button. Next the case worker may click (step 2) on the Orientation Date drop down menu and select the date to which the pre-enrollee is currently assigned. The case worker may then click (step 3) on the pre-enrollee's name in the right-hand “Assigned Clients” column. The ‘<’ button may be activated (step 4) to move that name to the left-hand column of “Unassigned Clients.”

The client's name will now appear back in the left-hand “unassigned clients” column. To re-assign him or her to a new date, the case worker may select a new orientation date, and click on the ‘>’ to move the name to the “assigned client column (as if the case worker were doing it for the first time).

Once the case worker has assigned pre-enrollees to an orientation date, the case worker may print out the attendance list for that session. On the Enrollment Process screen (FIG. 15), the case worker may click on the Orientation Administration button (step 1) and the Orientation Administration screen may appear. From the Orientation Administration screen, the user may activate a drop down menu and select a date for printing (step 2), followed by activation of the PRINT button (step 3).

The case worker may also view lists of pre-enrollees. In this regard, the case worker can use the View Pre-Enrollees softkey (step 1, FIG. 16) to see a list of all of the Pre-enrollees. The case worker can sort the list by name, inquiry date, or any of the other column headings by clicking on the column heading. The user may print the list by activating the Print softkey.

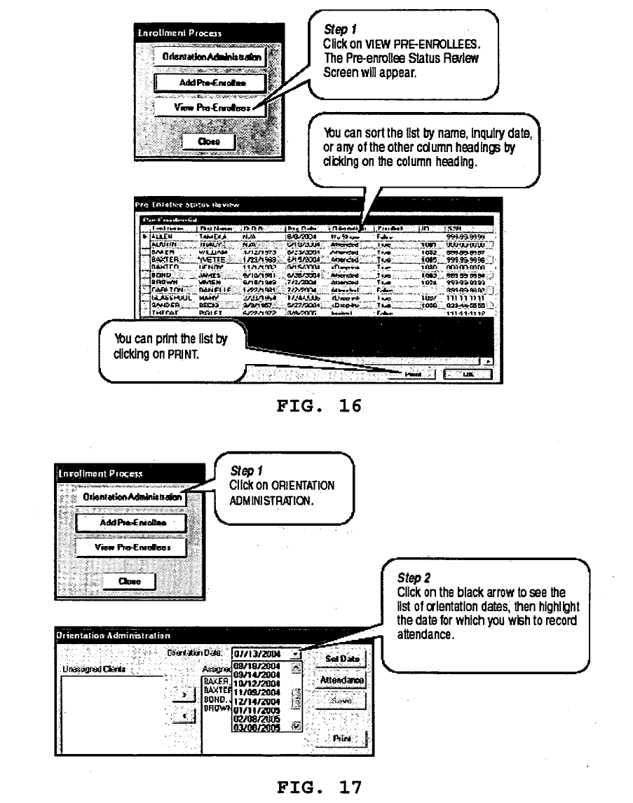

The case worker can also take attendance at group orientation sessions. In this case, after an orientation, the case worker may follow the steps below to record attendance. First, the case worker may click the Orientation Administration softkey (step 1, FIG. 17). The case worker may then click on the drop down arrow (step 2, FIG. 17) to find the date for which he/she wishes to record attendance, then click on the date. The names of Pre-enrollees assigned to that Orientation Date will appear in the “Assigned Clients” column

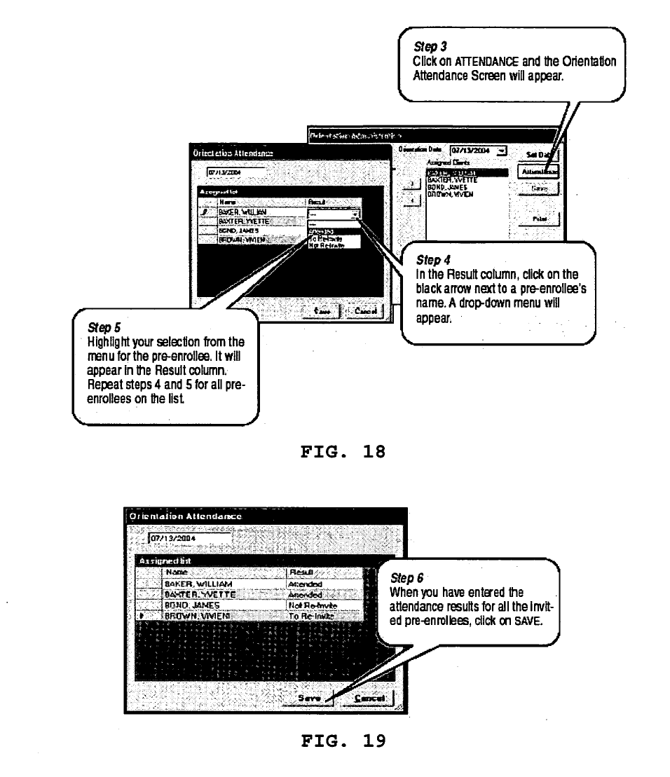

Next, the case worker may click (step 3, FIG. 18) on Attendance and the ORIENTATION ATTENDANCE window will appear, as it does in FIG. 18. In the Results column, click (step 4) on one of the ellipses next to the Pre-enrollees name. A drop down box will appear. Click on the arrow to reveal the choices. Finally, the case worker may highlight a selection (step 5). The case worker may repeat steps 4 and 5 for all pre-enrollees on the list. When the case worker has entered the results for each attendee, the case worker may click on Save (FIG. 19). The case worker's selection made will now appear in the Results column.

On the Main Screen (FIG. 20), click on the Client Button (step 1). The case worker may then enter the client's social security number in the Client Addition/Search screen (FIG. 20), then click on the Add button (step 2). The case worker may then verify that the Monthly category is selected and click OK (step 3).

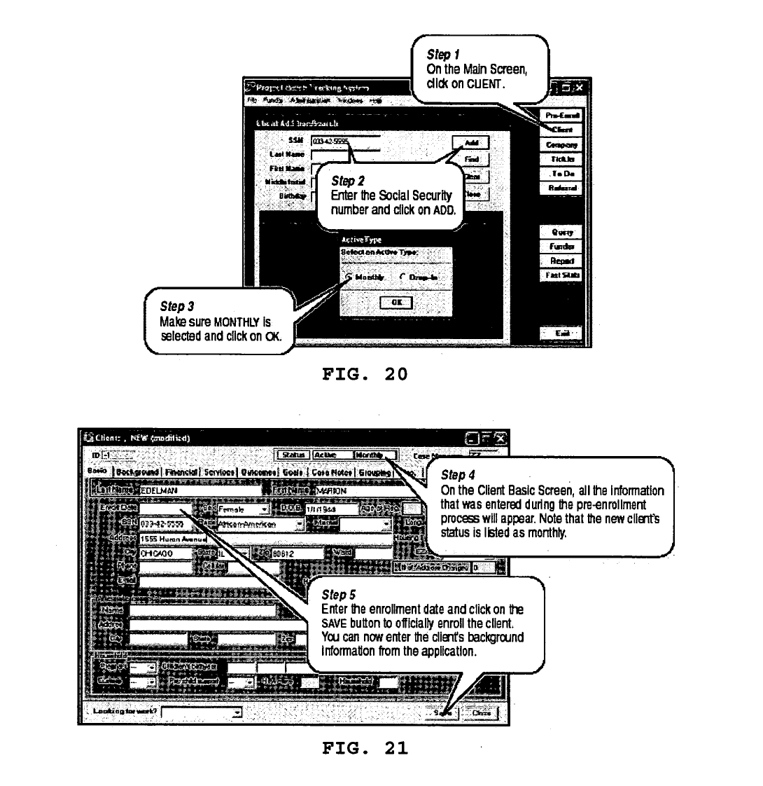

The Client Basic screen (FIG. 21) will appear. All the information that was previously entered during the pre-enrollment process will appear (step 4) on the screen. Note that the client's status will now be listed as monthly.

The case worker may then enter the enrollment date. The case worker may then click on the Save button (step 5) and the client will be officially enrolled in the system 10. The case worker may now enter the client's background information from the application.

The case worker may also add drop-in clients to the database. Generally speaking, Drop-in Clients are people who do not need the full range of services that case managers provide. They are able and comfortable using the site's resources without much assistance. The case worker may follow a particular site's protocols for deciding who qualifies as a Drop-in.

Drop-In Clients do not go through the pre-enrollment process. They fill out a detailed Enrollment Application when they first meet with staff. The information on this Enrollment Application is entered into the Tracking System using the various tabs on the Client Screen. The case worker may follow the steps below to add Drop-In Clients to the Tracking System.

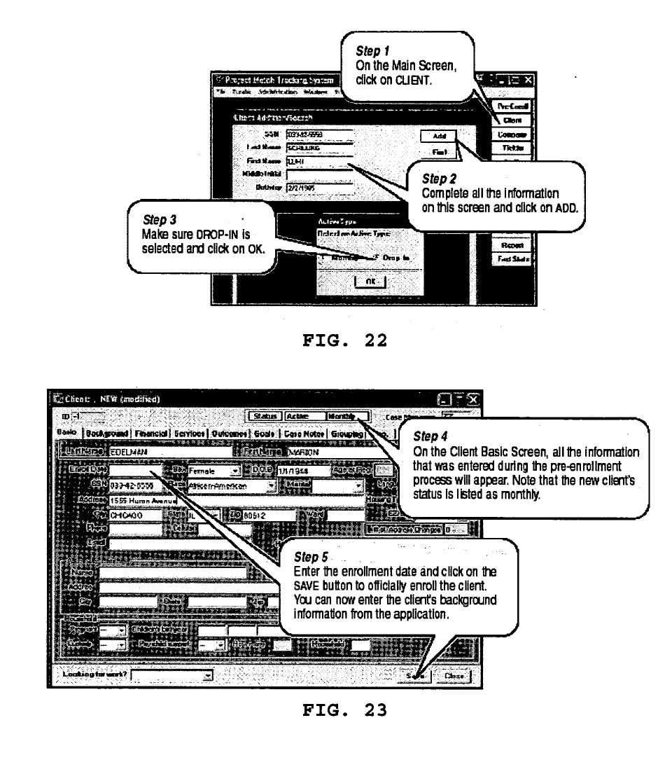

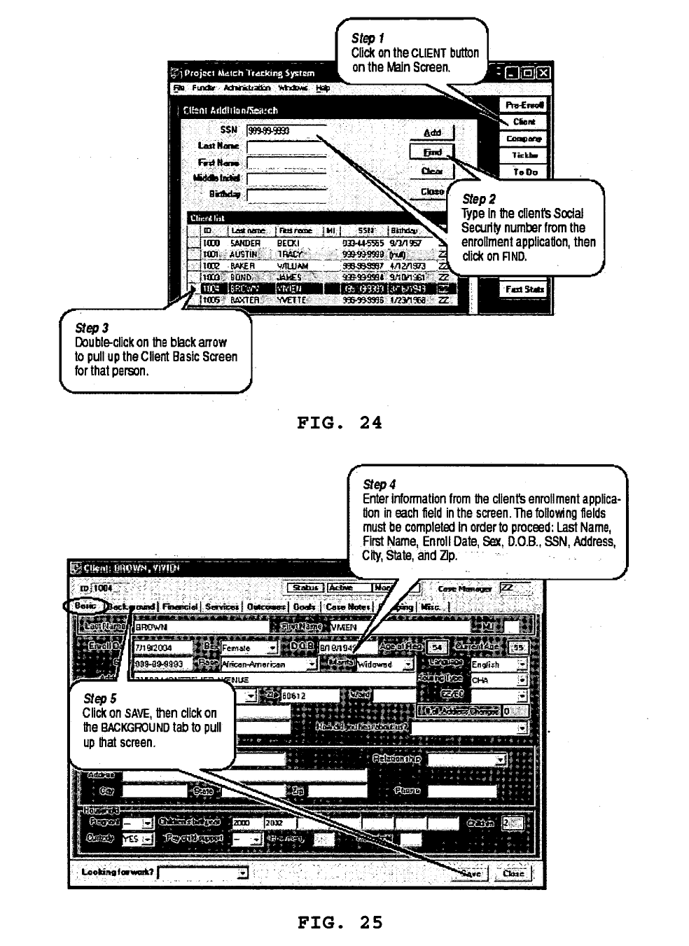

The case worker may enroll a drop-in client as follows. On the main screen, the case worker may click on the Client button (step 1, FIG. 22). Then, the case worker may complete the requested information in the Client Addition Search Box (step 2). Finally, the case worker clicks on the Drop-In (step 3) in the Active Types Box and then clicks OK.

A Client Basic screen will appear (FIG. 23). All of the information that was previously entered through the Client Addition/Search screen will appear (step 4). Note that the new client status is listed as drop-in.

The case worker may then enter the enrollment date (step 5, FIG. 23) and the client is officially enrolled. The case worker may then, fill in as much of the information as the case worker can on this screen (step 5). Required fields may include: Name, Gender, Address, Birth date, Zip code, and Social Security number. The case worker then clicks Save.

Entering of client background information will be considered next. On the main screen (FIG. 24), the case worker may client on the Client button (step 1). The Client Addition/Search screen will appear. The case worker may enter the client's social security number from the enrollment application, then clicks on Find (step 2). The Client list will appear (step 3), with the client being sought being marked by a black arrow. The case worker may double-click on the black arrow to bring up the Client Basic screen (FIG. 25).

In the Client Basic screen, the case worker may enter information (step 4) from the client's enrollment application in each field. The following fields must be completed in order to proceed: last name, first name, enrollment date, sex, date of birth (DOB), social security number (SSN), address, city, state and Zip. The case worker may then click on Save, then on the Background tab to pull up the screen (FIG. 26).

In the Client Background screen, the case worker may enter information from the client's enrollment application in each field (step 6, FIG. 26). The case worker may then click on the Financial tab to pull up that screen.

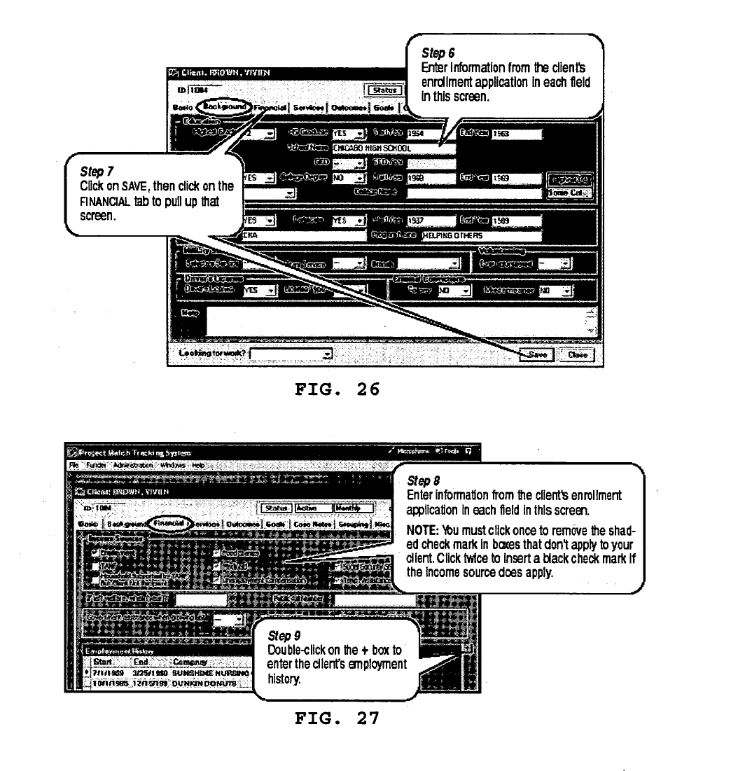

The Financial Tab Screen will appear (FIG. 27). Once again using the Enrollment Application, the case worker will fill in as much of the information as he/she can on this screen (step 8). Note that the case worker must click once to remove the shaded check marks in boxes that may not apply to his/her client. Click twice to insert a black check mark.

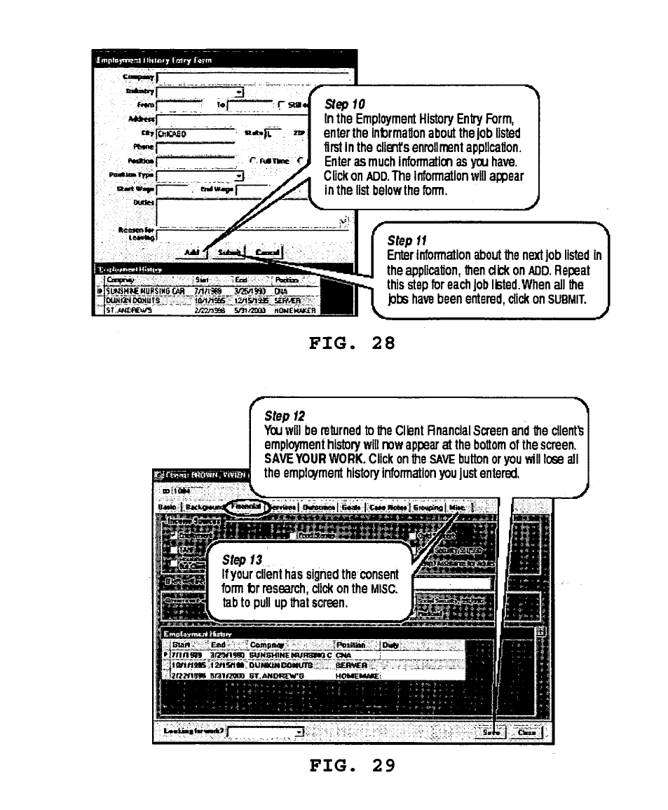

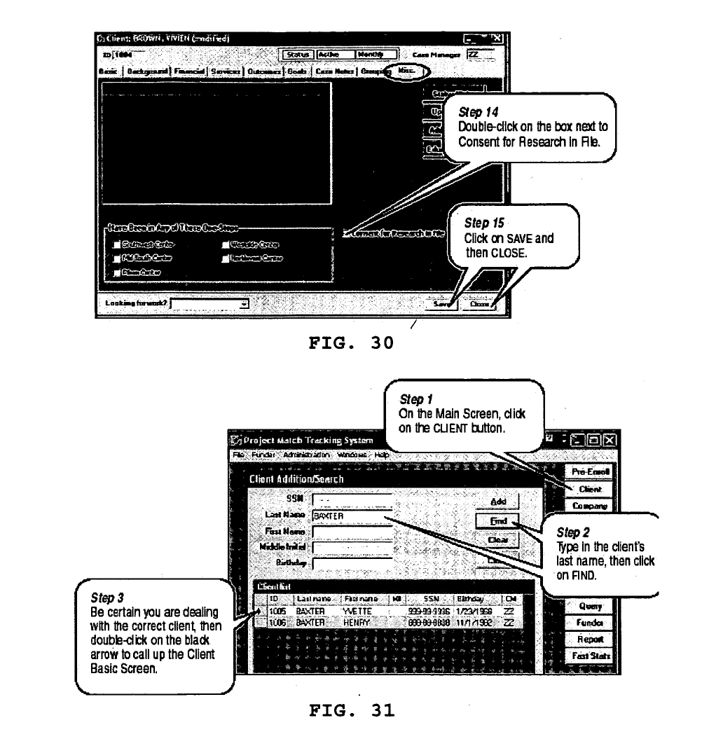

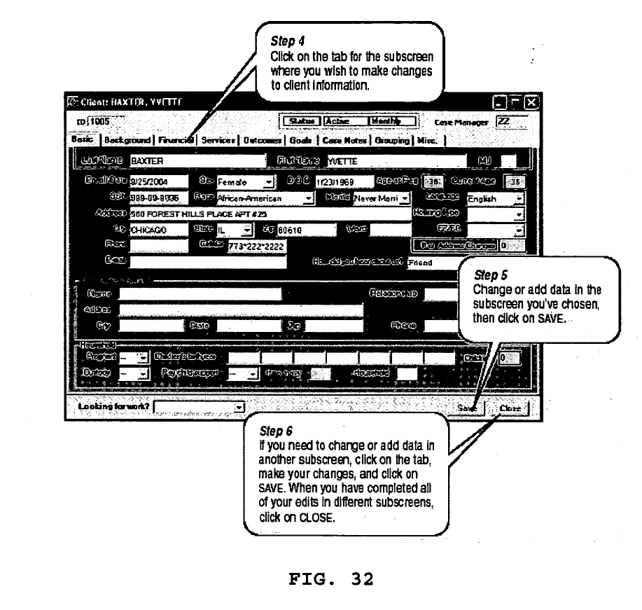

The case worker may double-click (step 9) on the +box to the far right on the screen to enter the client's Employment History Screen (FIG. 28). In the Employment History screen, the case worker may enter the information (step 10) about the job listed first in the client's enrollment application. The case worker may enter as much information as the case worker has and click on Add. The information will appear in the list below the form (FIG. 28).

The case worker may similarly enter information about the next job listed on the application, then click on Add. The case worker may repeat this step for each job on the application. When all of the jobs have been entered, the case worker may click on Submit.

The case worker may then be returned to the Client Financial screen (step 12, FIG. 29) and the client's employment history will now appear at the bottom of the screen. The case worker may then click on the Save button (step 12).

If the client has signed a consent form, the case worker may click on the Misc tab to pull up that screen (FIG. 30, step 13). On the Client Misc screen the case worker may double-click (step 14, FIG. 30) on the box next to Consent for Research. The case worker may then click on Save and Close (step 15) to complete entry of the enrollment application into the system 10.

The client background information may also be edited. On the main screen, the case worker may click on the Client button (step 1, FIG. 31) and the Client Addition/Search screen will appear. The case worker may type in the client's name (step 2) and the Find. All of the clients with that same last name will appear on the client list.

If the case worker is unsure of how to spell a client's name, the case worker may perform a “wild-card” search. To find a client using a wild-card search, the case worker may type in the first few letters of the client's first or last name into the appropriate box of the Client Addition/Search screen. All of the clients with that combination of letters in their name will appear. The case worker may then select the desired client.

The case worker may compare the social security number or birthday to be certain to select the correct client. The case worker may then double-click on the black arrow (step 3) to the left of the name selected. The Client Basic screen for that person will appear (FIG. 32).

The case worker may then click on the tab where he/she wishes to make changes (step 4, FIG. 32). The case worker may change any data that is incorrect (step 5) or add new information in the subscreen the case worker has chosen and then click on SAVE.

If the case worker needs to change or add data in another subscreen, he/she may click on the tab for the subscreen, make your changes (step 6), and click on SAVE. When he/she has completed all of the edits on the different subscreens, he/she may click on CLOSE.

Entering and editing services information will be discussed next. The Tracking System allows staff to enter and report on the information collected on the Daily Service Form (DSF). In the past, service information has been difficult to quantify and to categorize. The DSF organizes services by dividing them into a number of areas including, for example, case management, resource room and attempted contacts. Within each of these areas, services are grouped into categories (e.g., employment-related, retention-related, self- and family-related). The discrete service items are listed under each of these categories. These services may be “checked off” as they are provided on the paper version of the form; one DSF is completed for each participant visit and contact/attempted contact.

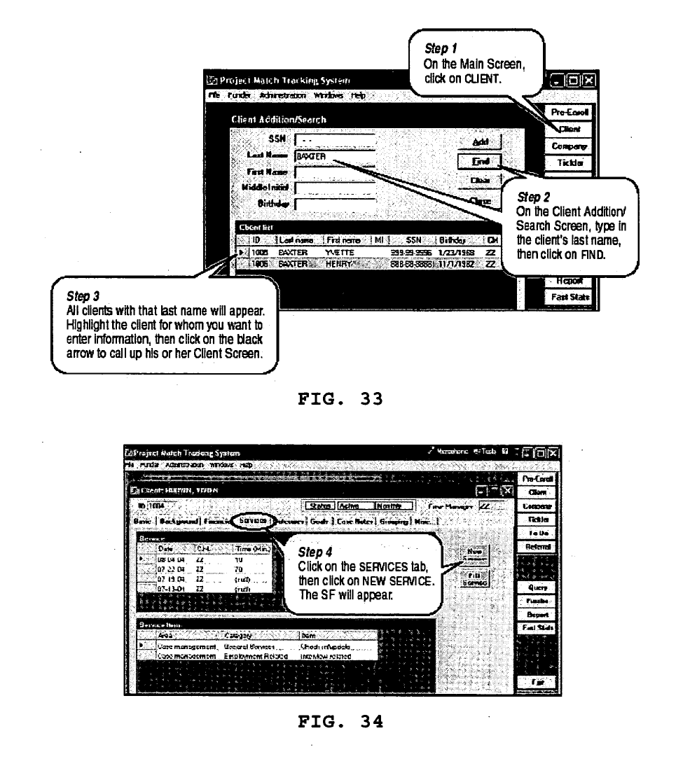

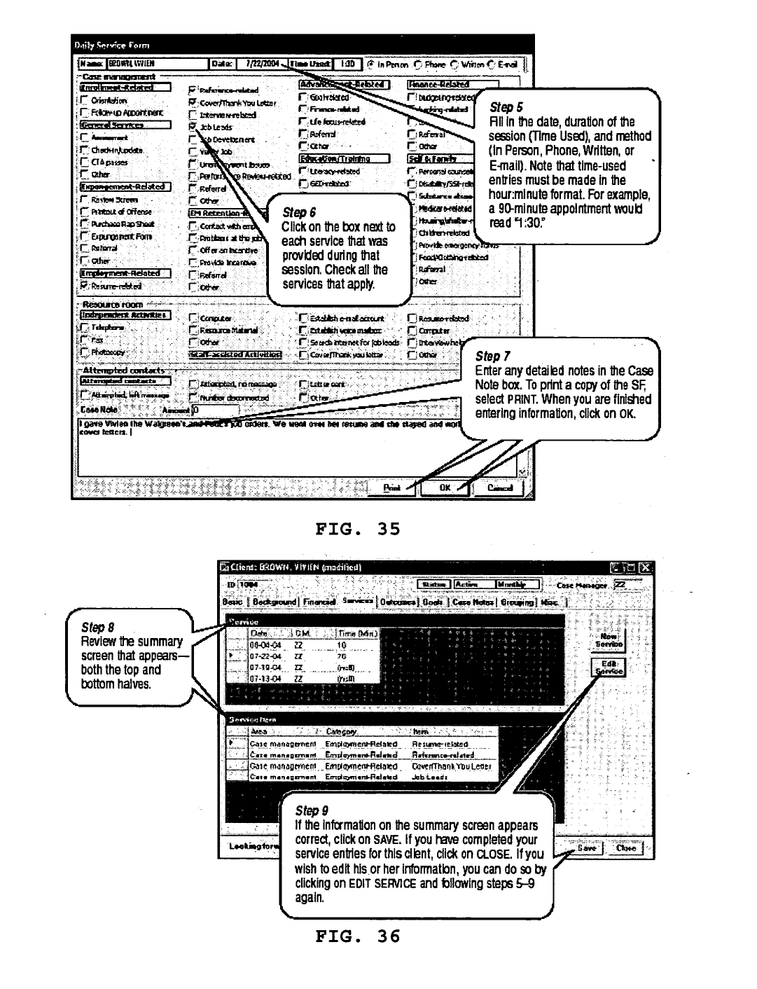

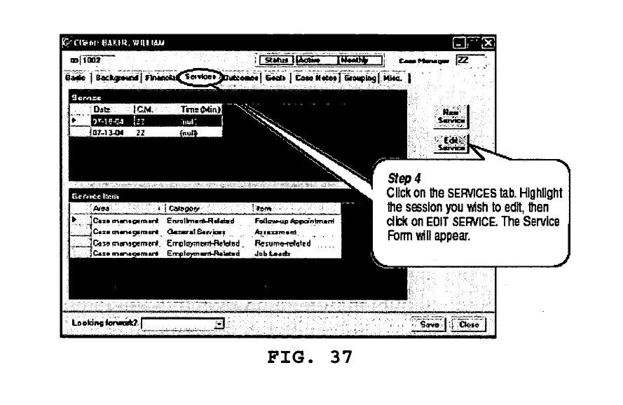

To enter services, the case worker may proceed to the Main Screen and clicks the Client Button (Step 1, FIG. 33). On the Client Addition/Search Screen that appears, the case worker types the client's last name, then clicks Find (Step 2). All clients with that last name will appear. The case worker verifies that he/she is dealing with the correct client and then clicks on the arrow (step 3) to call up the Client Screens (FIG. 34). The case worker clicks on the Services tab, then on “New Service” (step 4) and the DSF will appear (FIG. 35).

The case worker may then fill in the date, method and duration of the service. The case worker may then click the box(es) next to each service that was received by the client during that session on that date (step 6). The case worker may enter any Case notes in the case notes box, then click OK (Step 7).

The case worker may review the summary screen that appears (step 8, FIG. 35). Note that the top half of the screen tells the date and duration of the service, while the bottom half shows the type of service rendered on each date. If the information on the summary screen is correct, the case worker may click Save (Step 9). (If the case worker has completed his/her entries for this client, the case worker may then click Close.) If the case worker wishes to edit information, he/she can do so by clicking on the Edit Service button, and repeating steps 5-9.

The editing of service information will be discussed next. The case worker may edit most service information after it has been entered into the system by following the steps below. In this regard, the case worker may follow the same steps as for Entering Service Information, above (Steps 1-3, FIG. 33). The case worker may then click on the Services tab, Review the Services listed and their dates and durations, highlight the service he/she wishes to edit and then click on “Edit Service” (step 4).

The case worker may enter the new or changed information on the DSF, then click OK (step 5, FIG. 37). The case worker may review the revised summary sheet that appears. If it looks correct, the case worker may click Save, then Close if he/she is finished entering information about this client.

The case worker may enter and edit employers, service providers, and education/training organizations. In this regard, the Tracking System helps Case Managers to keep an accurate record of every client's employment history by keeping data about employers who have hired clients. The Tracking System also maintains data on employers who have not yet hired clients but who, from time to time, have positions available that would be appropriate for clients. Data on social service providers, educational institutions and organizations that provide training to clients are also maintained on the Tracking System. Like all of the data entered into the Tracking System, employer data must be entered accurately to be most useful.

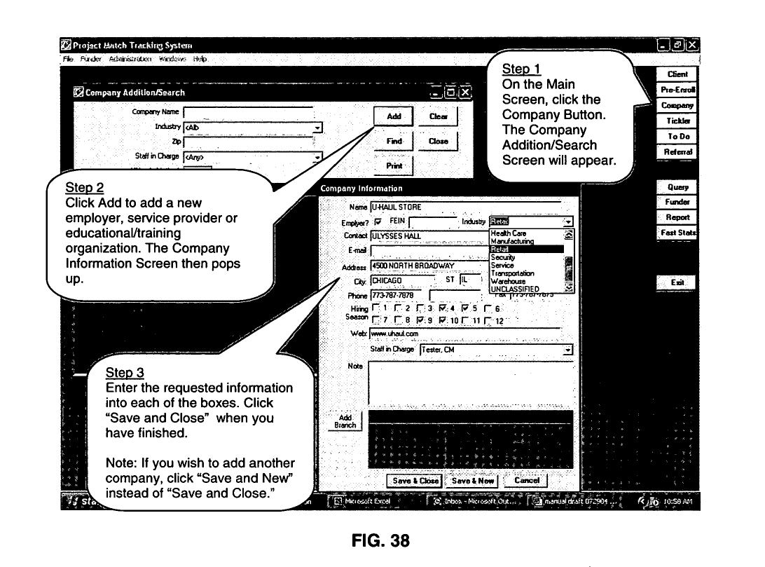

To enter information about employers/service providers/education and training organizations, the case worker may, on the Main Screen, click the Company Button (Step 1, FIG. 38). The Company Addition/Search Screen will appear. The case worker may then click Add to add a new employer, service provider or educational/training organization (Step 2). The Company Information Screen then pops up. The case worker may enter the requested information into each of the boxes and click “Save and Close” when he/she has finished (Step 3). Note: If the case worker wishes to add another company, click “Save and New” instead of “Save and Close.” A fresh blank Company Addition/Search Screen will appear.

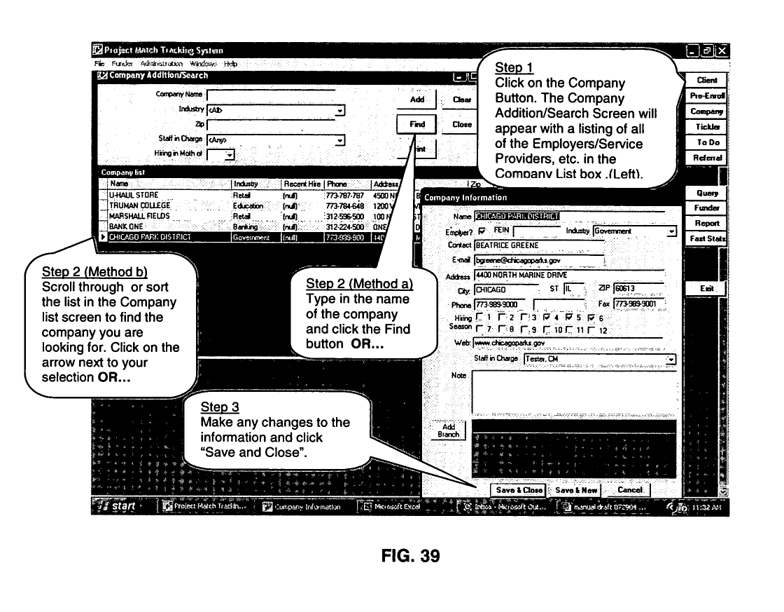

The case worker may also find and edit information about employers/service providers/education and training organizations. In this regard, the case worker may click on the Company Button (Step 1, FIG. 39). The Company Addition/Search Screen will appear with a listing of all of the Employers/Service Providers, etc. in the Company List box. Notice that the list is arranged in columns with the headings, Name, Industry, Previous Hire, Address, and Zip. There are two ways to find the company the case worker is looking for. Either: (Method A) Type in the name of the company and click the Find button or, (Method B) scroll through/sort the list in the Company list screen to find the company you are looking for (Step 2). The case worker may click on the arrow next to his/her selection. The case worker may then make any changes (step 2) to the information and click “Save and Close” (Step 3).

The case worker may also enter and edit client outcome information. One of the hallmarks of the Tracking System 10 is its ability to efficiently keep records of what active, monthly clients are doing every month. This information can be manually recorded on the Monthly Tracking Form. It is then entered into the Tracking System by using the Outcomes tab of the Client Screen.

Outcomes may be entered or updated at least once a month for every active, monthly client. Outcomes must be entered or updated at least once a quarter for every active, quarterly client. The Tickler Screen that shows up when a case manager first logs in shows which monthly and quarterly clients have not yet had an outcome entered or updated (in the required time period).

In this regard, services record what staff worked on with the client (case management services) and/or what resource room services were used by the client; outcomes record what happened to the client as a result of these efforts, such as:

Did the person start a job?

Did the person receive a promotion?

Did the person graduate from a drug rehab program?

Did the client open a bank account?

Is the client actively looking for work, although they didn't start a job?

What types of outcomes does the system track? Because the system 10 is based upon the assumption that people must learn to balance multiple roles in order to find and keep a job, the tracking system records outcomes in a variety of areas (e.g., employment (EM), education (ED), training (TR), community service (CS), criminal record expunction (EX), housing (HO), financial (FI), legal (LE), self and family (SF), etc.). When the case worker enters outcome information into the tracking system, the case worker will choose from a drop-down menu that lists one or more activities for each one of these areas. Once the case worker has selected an outcome area, a further outcome detail menu may be provided that allows the case worker to enter further detail about the outcome. If the case worker should require more detail as to outcome options, the case worker may select an outcome selection help function.

The outcome selection help function may provide the detail shown in FIG. 56 which details the menu and submenu options available to the case worker for entering outcome information. The outcome options entered through the outcome feature of the system is added to a social services client file 32 within the database 16 and functions to provide a comprehensive history of the progress of the social services client in a manner that has not been available in the past.

Some of the activities in the drop-down menu are ongoing, such as a job or school. These outcomes are generally known as “placements” in the workforce development field. Other activities, such as opening a bank account, are referred to as “one-time” activities. In a particular month, a client could have one placement AND a one-time activity. Both can be entered in the Tracking System. In fact, each client could have any combination of placements and one-time activities occur in a month. The goal is to enter all of the outcome information on the client for the month that the case worker discovers during the case worker's conversations with the client.

If a case worker should determine that a client objective has been achieved, then the case worker enters the outcome “objective complete”. However, there may be times when an active, monthly client has not achieved an outcome for the month-neither a placement nor a one-time activity. Something still must be recorded in the outcomes section of the Tracking System for the month. There are two choices in the drop-down activity menu relating to this “No Outcome” (NO) category: “Actively Looking for Work” and “Active-Other”. A case manager will only record the outcome, “actively looking for work”, if there are services listed that back this up. Otherwise, “active-other” should be selected.

It may be noted that the Outcomes shown in FIG. 56 are, in fact, objectives of the client. In this regard, an outcomes processor 24 receives the outcome information received from the case worker and determines which entry should be scheduled for follow-up and which entry is a one-time activity.

Those entries scheduled for follow-up will be prompted on the Tickler screen. An entry (a participant's name) scheduled for follow-up will appear on the Tickler screen every month prompting the case worker to make an objective complete entry and will remain on the tickler screen until the objective complete entry has been made.

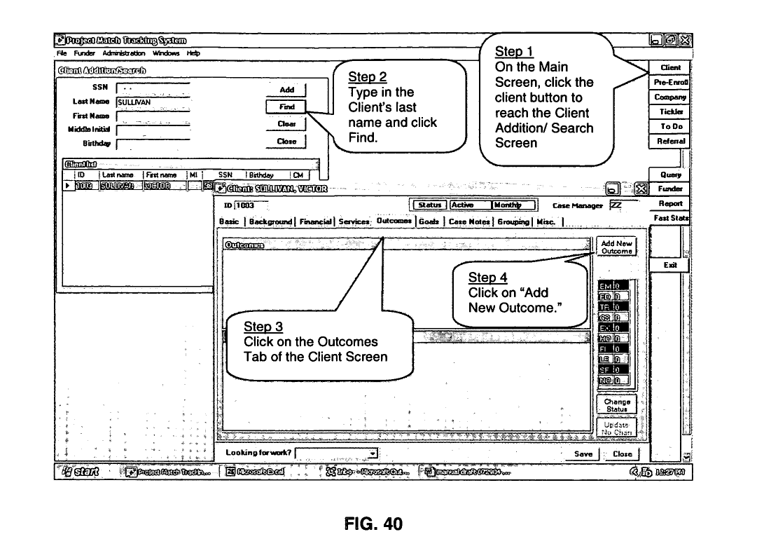

In this regard, on the Main Screen, the case worker may click the client button to reach the Client Addition/Search Screen (Step 1, FIG. 40). The case worker may then type in the Client's last name and click Find (Step 2). The Client Screens will appear. Then case worker may then click on the Outcomes tab of the Client Screen (Step 3). The case worker may then click on “Add New Outcome” (Step 4).

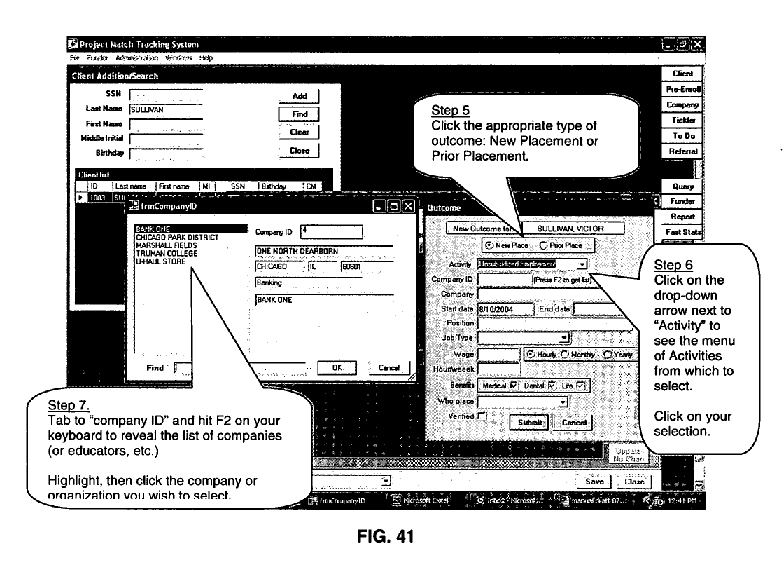

On the Screen that appears, the case worker may fill in the information requested. The case worker may start by Clicking the appropriate type of outcome-New Placement or Prior Placement (step 5, FIG. 41). Note: One-Time Activities are part of this menu.

The case worker may click on the drop-down arrow next to “Activity” to see the menu of Activities from which to select. The case worker may click on the appropriate selection (step 6).

The case worker may tab to “company ID” and hit F2 on the keyboard to reveal the list of companies (or educators/trainers/social service agencies). The case worker may highlight, then click the company or organization you wish to select (step 7).

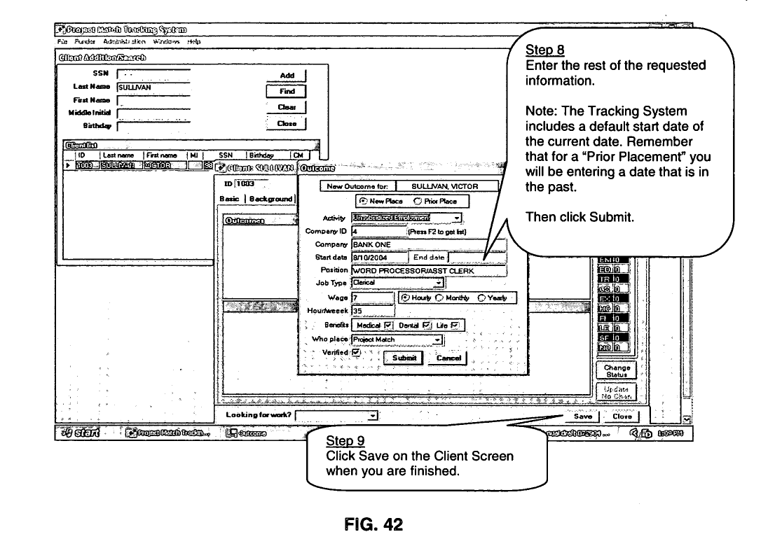

The case worker may enter the rest of the requested information (step 8, FIG. 42). It should also be remembered that for a “Prior Placement” the case worker will be entering a date that is in the past. The case worker may then click Submit and Save on the Client Screen when the case worker is finished (step 9).

The editing of client outcome information will be discussed next. If the case worker has incorrectly entered client outcome information, the case worker can follow the following steps to make corrections.

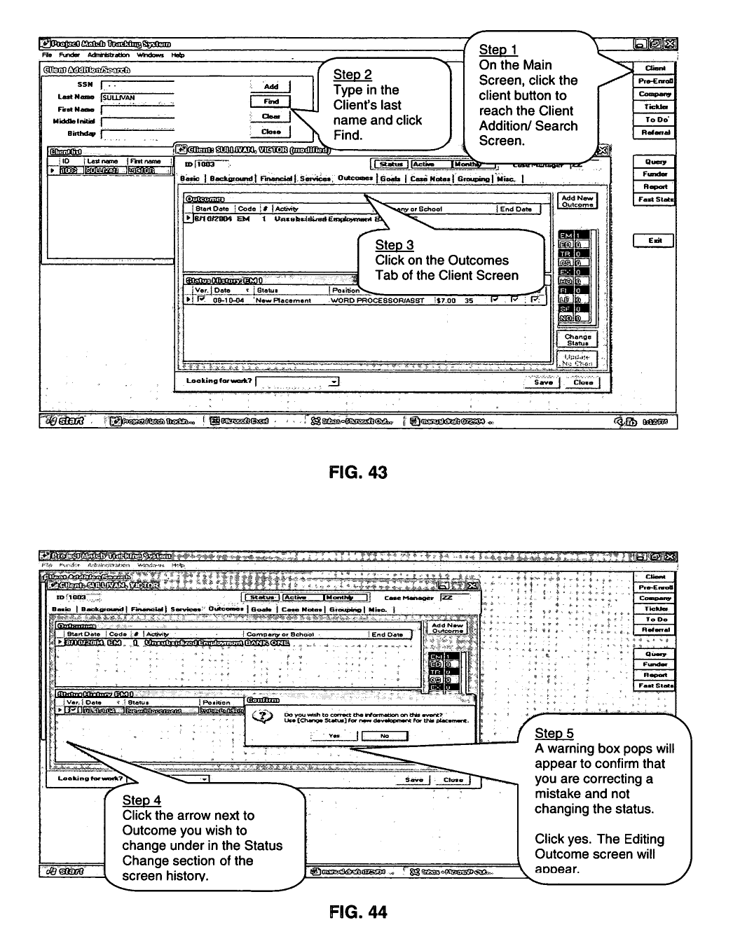

On the Main Screen, the case worker may click the client button (step 1, FIG. 43) to reach the Client Addition/Search Screen. The case worker may then type in the Client's last name and click Find (step 2). The Client Screens will appear.

The case worker may then click on the Outcomes tab of the Client Screen (step 3). The case worker may then click the arrow (step 4), FIG. 44) next to the Outcome that the case worker wishes to change in the Status Change section of the screen history.

A warning box pops will appear to confirm that the case worker is correcting a mistake and not changing the status. The case worker may then click yes (step 5). The Editing Outcome screen will appear.

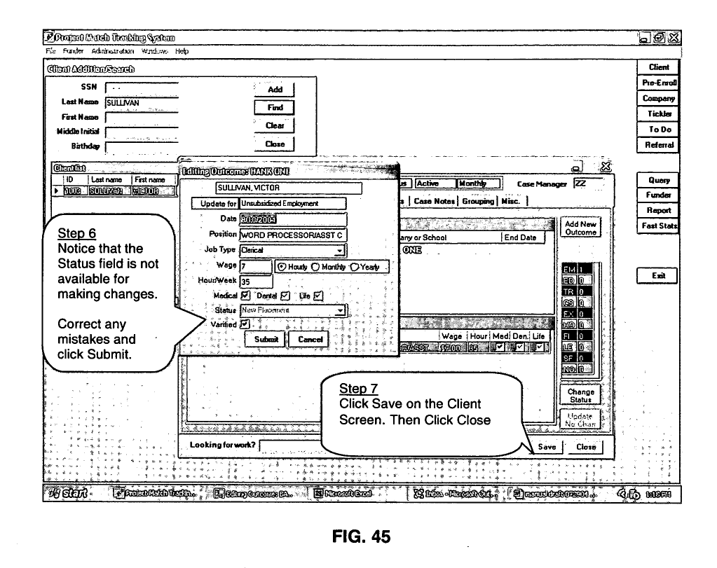

The case worker may correct any mistakes and click Submit (step 6, FIG. 45). The case worker may then click Save on the Client Screen and then Close (step 7).

The case worker may also change client status information. If a client reports a change in status—e.g. a promotion, lay-off, entry into a new training program, the case worker may follow the steps below to change the status of the client in the Tracking System 10.

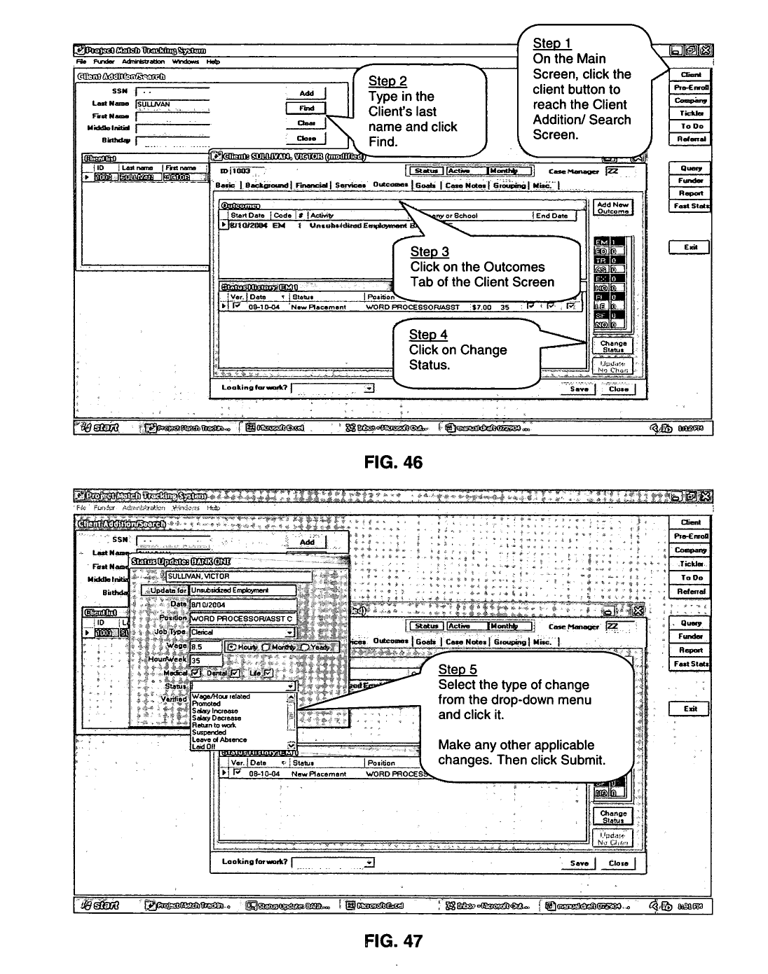

On the Main Screen, the case worker may click the client button (step 1, FIG. 46) to reach the Client Addition/Search Screen. The case worker may then type in the Client's last name and click Find (step 2). The Client Screens will appear. The case worker may then click on the Outcomes tab of the Client Screen (step 3) and click on Change Status (step 4).

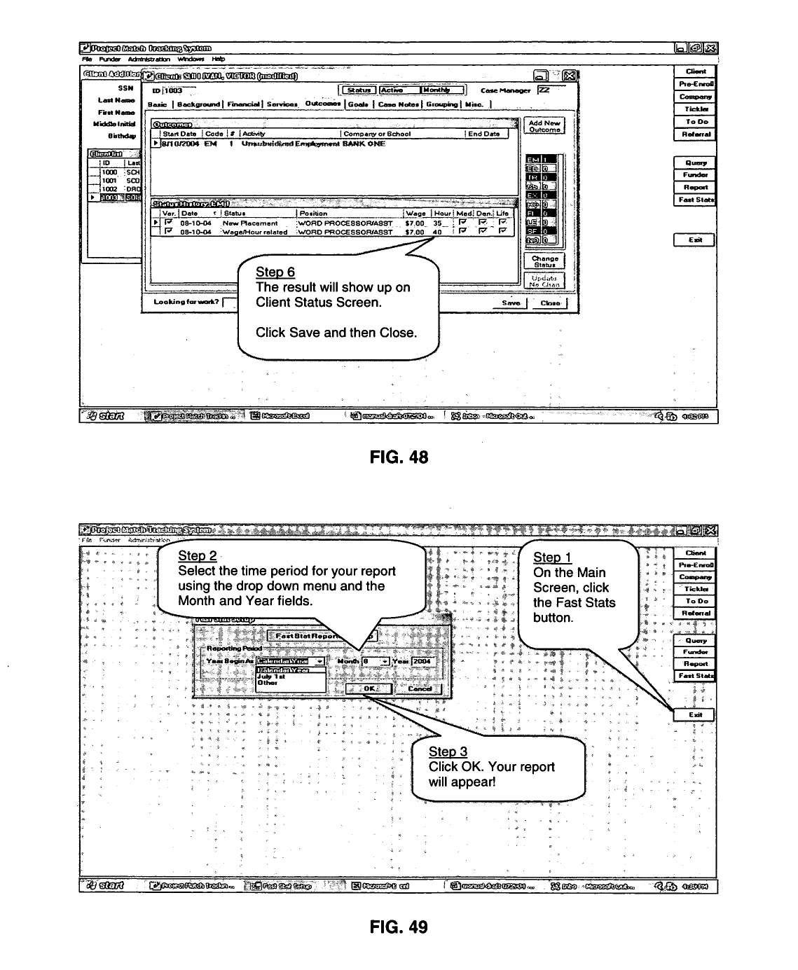

The case worker may then select the type of change from the drop-down menu and make any other applicable changes (step 5, FIG. 47) and then click Submit. The result will show up on the Client Status Screen and the case worker may click Save (step 6, FIG. 48).

The system 10 may also provide a convenient way to retrieve statistics. The Fast Stats button provides quick and concise information about client enrollment, service and outcome information for a particular time period. This information can then be printed following the steps below.

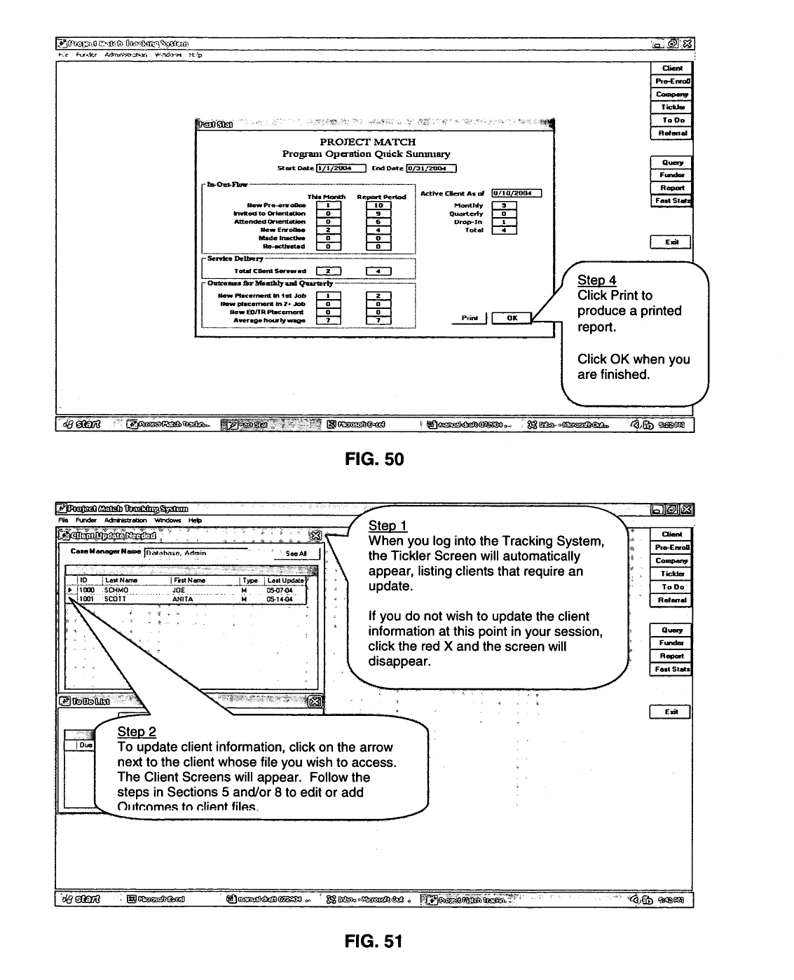

On the Main Screen, a user may click the Fast Stats button (step 1, FIG. 49) to activate a statistics processor 22. The user may then select the time period for the report using the drop down menu and the Month and Year fields (step 2). The user may then click OK (step 3) and the report will appear. The user may click Print to produce a printed report and OK when he/she is finished (step 4, FIG. 50).

Returning now to the Tickler screen, the Tickler Screen appears each time the case worker logs into the system. The case worker can also access the Tickler Screen by clicking on the Tickler button on the Main Screen.

The Tickler Screen shows which Monthly and Quarterly clients have not yet had an Outcome entered or updated in the required time period. The case worker may follow the site's protocols for how frequently updates must be entered.

When the case worker logs into the Tracking System (step 1, FIG. 51), the Tickler Screen will automatically appear, listing clients that require an update. If the case worker does not wish to update the client information at this point in his/her session, the case worker may click the red X and the screen will disappear.

To update client information, the case worker may click on the arrow (e.g., a hyperlink) next to the client (step 2) whose file the case worker wishes to access. The Client Screens will appear and the case worker may follow the steps outlined above to edit or add Outcomes to client files.

The To Do list screen will be considered next. The To Do List Screen is a tool that assists Users in creating lists of tasks with due dates. The tasks may be for an individual user or may be “broadcast” to the entire staff.

The To Do List Screen, like the Tickler Screen, may appears automatically each time the case worker logs into the system. It will list tasks with due dates that correspond to warning periods that the case worker sets. The case worker can click the red X and the screen will disappear.

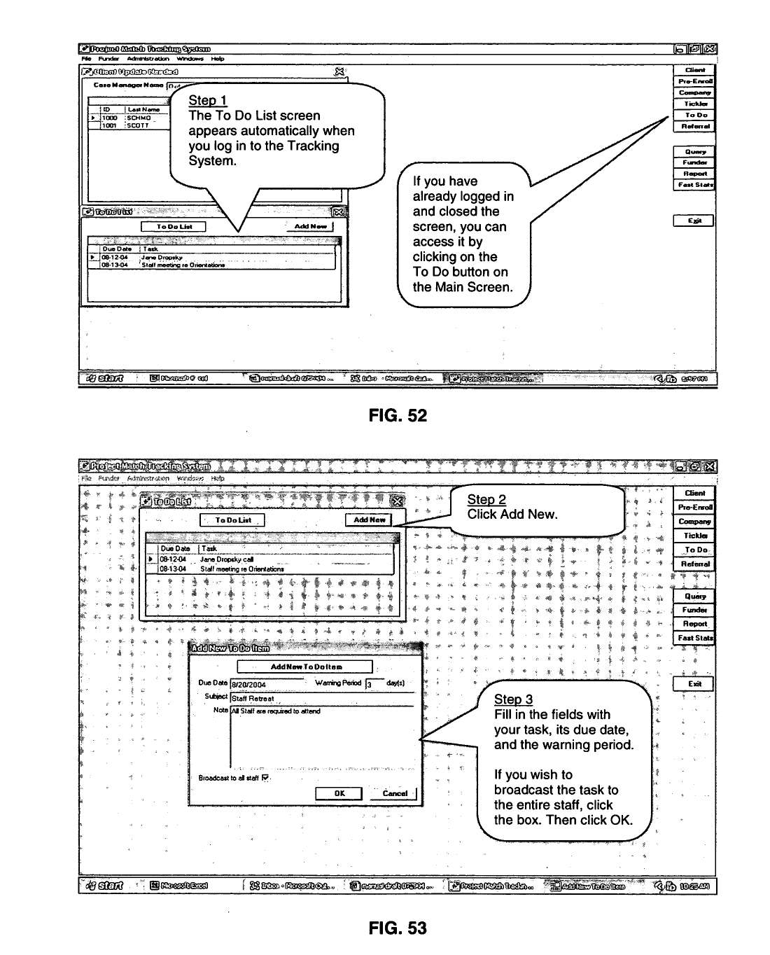

The To Do List screen appears automatically when the case worker logs into the Tracking System (step 1, FIG. 52). If the case worker has already logged in and closed the screen, the case worker can access it by clicking on the To Do button on the Main Screen.

To add information, the case worker may click Add New (step 2, FIG. 53). The case worker may then fill in the fields with the case worker's task, its due date, and the warning period (step 3). If the case worker wishes to broadcast the task to the entire staff, the case worker may click the appropriate box and then OK.

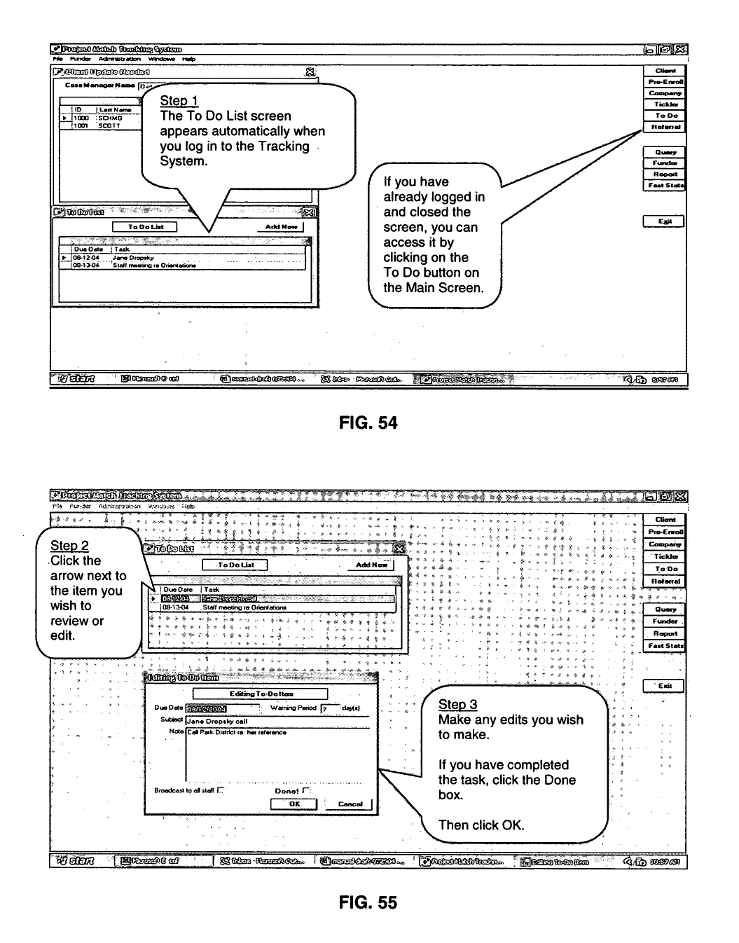

The case worker may also review and edit the To Do list (step 1, FIG. 54). If the case worker has already logged in and closed the screen, he/she can access it by clicking on the To Do button on the Main Screen.

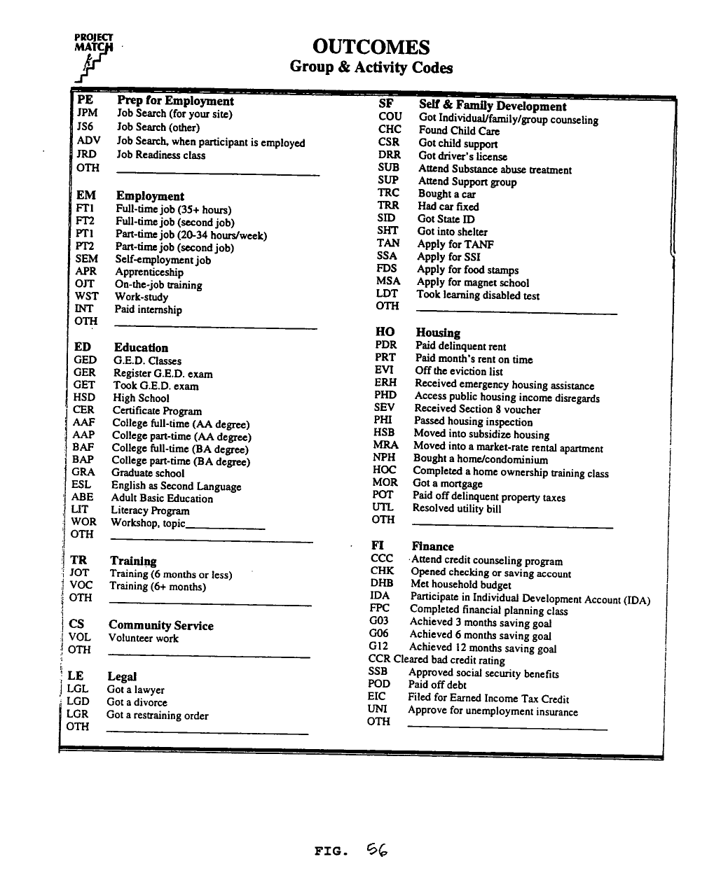

The case worker may then click the arrow next to the item he/she wishes to review or edit (step 2, FIG. 55). The case worker may then make any edits he/she wishes to make (step 3). If the edits have been completed, then the case worker may click Done and then OK (step 3).

A specific embodiment of method and apparatus for social services clients has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. A method of tracking a plurality of social services clients, such method at least partially implemented by the programmed computer to effect the following steps:
providing a social services client of the plurality of social services clients with a customized set of services that depend upon a level of service required by the client;
the programmed computer prompting a case worker to record the set of services received by the client within a client file located within the programmed computer;
the programmed computer prompting the case worker to select one or more client objectives;
recording the client objectives selected by the case worker within the client file as a pending client objective where each client objective is a case worker defined action that is undertaken by the client; and
the programmed computer prompting a case worker to make contact with the social services client at an end of a regularly scheduled follow-up time period for each of the one or more pending client objectives.

2. The method of tracking the social services client as in claim 1 wherein the step of the case worker selecting the one or more client objectives further comprises the programmed computer providing the case worker with a menu of predetermined possible client objectives.

3. The method of tracking the social services client as in claim 2 wherein the menu of client objectives further comprises two or more client objectives selected from the group consisting of employment, education, training, community service, criminal record expunction, housing, financial, legal, self and family.

4. The method of tracking the social services client as in claim 1 further comprising the case worker subsequently contacting the client in response to the prompt of the programmed computer.

5. The method of tracking the social services client as in claim 4 further comprising the programmed computer prompting the case worker to enter outcomes for each of the one or more pending client objectives during the subsequent contact with the client.

6. The method of tracking the social services client as in claim 5 wherein the step of prompting the case worker further comprises the programmed computer displaying a tickler screen containing a list of social service clients of the plurality of social service clients requiring follow-up.

7. The method of tracking the social services client as in claim 6 further comprising providing a hyperlink from the list of social services clients to a respective client record for each client within the list of clients.

8. The method of tracking the social services client as in claim 7 further comprising the case worker selecting a hyperlink of a client from within the list of clients to access a client record of the selected client.

9. The method of tracking the social services client as in claim 8 further comprising the programmed computer providing the case worker with a menu of possible outcomes for each social service objective of the selected client.

10. The method of tracking the social services client as in claim 9 further comprising defining one entry of the menu of possible outcomes as objective complete.

11. The method of tracking the social services client as in claim 10 further comprising defining one entry of the menu of possible outcomes as no change.

12. The method of tracking the social services client as in claim 8 wherein the client record further comprises providing a softkey for adding a new client objective to the one or more client objectives.

13. The method of tracking the social services client as in claim 1 further comprising the programmed computer prompting the case worker to enter demographics of the social services client and to open a file that is saved in a database of the programmed computer for the client.

14. The method of tracking the social services client as in claim 13 further comprising assigning a unique identifier to the social services client that is used as a file identifier.

15. The method of tracking the social services client as in claim 1 further comprising the programmed computer generating a summary report regarding the plurality of social services clients.

16. An programmed computer that tracks a plurality of social services clients comprising:
means within the programmed computer for prompting a case worker to record a set of services received by the client within a client file located within the programmed computer;
means within the programmed computer for prompting the case worker to select one or more client objectives;
means within the programmed computer for recording the client objectives selected by the case worker within the client file as a pending client objective where each client objective is a case worker defined action that is undertaken by the client; and
means within the programmed computer for prompting a case worker to make contact with the social services client at an end of a regularly scheduled follow-up time period for each of the one or more pending client objectives.

17. The programmed computer as in claim 16 wherein the means for selecting the one or more client objectives further comprises means within the programmed computer for providing the case worker with a menu of predetermined possible client objectives.

18. The programmed computer as in claim 17 wherein the menu of client objectives further comprises two or more client objectives selected from the group consisting of employment, education, training, community service, criminal record expunction, housing, financial, legal, self and family.

19. The programmed computer as in claim 18 further comprising means within the programmed computer for prompting the case worker to enter outcomes for each of the one or more pending client objectives during a subsequent contact with the client.

20. The programmed computer as in claim 17 wherein the means for prompting the case worker further comprises means within the programmed computer for displaying a tickler screen containing a list of social service clients of the plurality of social service clients requiring follow-up.

21. The programmed computer as in claim 20 further comprising a hyperlink from the list of social services clients to a respective client record for each client within the list of clients.

22. The programmed computer as in claim 17 further comprising means within the programmed computer for providing the case worker with a menu of possible outcomes for each social service objective of the selected client.

23. The programmed computer as in claim 22 further comprising defining one entry of the menu of possible outcomes as objective complete.

24. The programmed computer as in claim 23 further comprising defining one entry of the menu of possible outcomes as no change.

25. The programmed computer as in claim 22 wherein the menu of outcomes further comprises means for providing a softkey for adding a new client objective to the one or more client objectives.

26. The programmed computer as in claim 17 further comprising means within the programmed computer for prompting the case worker to enter demographics of the social services client and to open a file that is saved in a database of the programmed computer for the client.

27. The programmed computer as in claim 17 further comprising means within the programmed computer for generating a summary report regarding the plurality of social services clients.

28. An programmed computer that tracks a plurality of social services clients comprising:
a services tracking application within the programmed computer that prompts a case worker to record a set of services received by the client within a client file located within the programmed computer;
a client tracking application within the programmed computer that prompts the case worker to select one or more client objectives;
reporting application within the programmed computer that records the client objectives selected by the case worker within the client file as a pending client objective where each client objective is a case worker defined action that is undertaken by the client; and
a prompting application within the programmed computer that prompts a case worker to make contact with the social services client at an end of a regularly scheduled follow-up time period for each of the one or more pending client objectives.

29. The programmed computer as in claim 28 wherein the means for selecting the one or more client objectives further comprises an outcomes menu within the programmed computer that provides the case worker with a set of predetermined possible client objectives.

30. The programmed computer as in claim 28 wherein the menu of client objectives further comprises two or more client objectives selected from the group consisting of employment, education, training, community service, criminal record expunction, housing, financial, legal, self and family.
